(19) United States
(12) Patent Application Publication
(10) Pub. No.: US 2015/0120370 A1
(43) Pub. Date: Apr. 30, 2015

(54) ADVANCED PLANNING IN A RAPIDLY CHANGING HIGH TECHNOLOGY ELECTRONICS AND COMPUTER INDUSTRY THROUGH MASSIVELY PARALLEL PROCESSING OF DATA USING A DISTRIBUTED COMPUTING ENVIRONMENT

(71) Applicant: STEELWEDGE SOFTWARE, INC., Pleasanton, CA (US)

(72) Inventors: Chandra P. Agrawal, Pleasanton, CA (US); Glen William Margolis, Danville, CA (US)

(21) Appl. No.: 14/067,969

(22) Filed: Oct. 31, 2013

(51) Int. Cl. G06Q 10/06

(52) U.S. Cl. CPC G06Q 10/06315
USPC 705/7.25

(57) ABSTRACT

A method aggregates an advanced planning and forecasting raw data by multiple database management systems (DBMS) communicatively coupled to an extensible computation engine. Performing an advanced planning simulation modeling a multi-level bill of materials, a periodic model revision, and an obsolesce risk of the computer and electronics industry supply chain by multiple processing nodes of the extensible computation engine. The method caches a result of the advanced planning simulation in an extensible memory cache communicatively coupled to the extensible computation engine and edge caching the result of the advanced planning simulation in an edge cache server near a geographical point of origin of the advanced planning and forecasting raw data. The extensible computing engine may employ a large number of processors (or separate computers) to perform a set of coordinated computations in parallel through a distributed computing infrastructure (e.g., cloud based infrastructure) for a specific advanced planning query.

### PRIORITY CLAIM

This disclosure claims priority to, and incorporates herein by reference the entire specification of U.S. Utility patent application Ser. No. 13/899,595 filed May 22, 2013 and titled BUSINESS ENTERPRISE SALES AND OPERATIONS PLANNING THROUGH A BIG DATA AND BIG MEMORY COMPUTATIONAL ARCHITECTURE.

### FIELD OF TECHNOLOGY

This disclosure relates generally to computing technology, advanced planning and forecasting and, in one example embodiment, to a method and system of advanced planning in a rapidly changing and high-technology electronic and computer industry supply chain through massively parallel processing of data using a distributed computing environment.

### BACKGROUND

An electronics supply chain may be volatile and/or complex. For example, the volatility of the electronics supply chain may be caused by unpredictable demand for a product for which there is a lack of historical data. In addition, the electronics supply chain may be complex due to a multi-level bill of materials (e.g., a list of raw materials, sub-assemblies, intermediate assemblies, sub-components, parts and/or the quantities of each needed to manufacture the product). Due to the volatility and/or complexity of the electronics supply chain, a traditional advanced planning simulation may not be fast enough to respond to a real-time change in the electronics supply chain. For example, if a component has an unexpectedly long lead time, this may impact inventory of downstream sub-assemblies and/or products. The volatility and/or complexity of the electronics supply chain may also result in an inaccurate forecast in which demand is not well anticipated, thereby creating a shortage or an overstocked inventory.

While an off-the-shelf spreadsheet application loaded on a personal computer may have been sufficient in handling the advanced planning and forecasting needs of a company in years past, today's enterprises require technology solutions that can handle data volumes far in excess of what was once thought possible. For example, today's business enterprise may rely on internal and external supply chains that create data combinations running into the millions and, possibly, into the billions. Moreover, a standalone spreadsheet on one computer may not be accessible to numerous on-the-ground sales managers, finance planners, and high-level executives resident in different locations around the globe. Finally, a standalone spreadsheet application may not be compatible with existing customer relations management (CRM) or enterprise resource planning (ERP) solutions that contain much of the raw data needed to craft an effective advanced planning and forecasting.

In addition, an enterprise undertaking advanced planning and forecasting in the highly competitive business enterprise may face unique planning challenges. Therefore, it would be desirable to have an advanced planning and forecasting that is both agile and powerful enough to perform large scale calculations and simulations in a short amount of time.

### SUMMARY

Disclosed are methods and systems of advanced planning in a rapidly changing and high-technology electronic and computer industry supply chain through massively parallel processing of data using a distributed computing environment.

In one aspect, a machine-implemented method in a computer and electronics industry supply chainincludes: aggregating an advanced planning and forecasting raw data by one or more database management systems (DBMS) communicatively coupled to an extensible computation engine; performing an advanced planning simulationmodeling a multi-level bill of materials of the computer and electronics industry supply chain, a periodic model revision of the computer and electronics industry supply chain, and an obsolesce risk of the computer and electronics industry supply chain, by one or more processing nodes of the extensible computation engine, using the advanced planning and forecasting raw data; caching a result of the advanced planning simulation in an extensible memory cache communicatively coupled to the extensible computation engine; and edge caching the result of the advanced planning simulation in an edge cache server near a geographical point of origin of the advanced planning and forecasting raw data. The extensible computing engine may employ a large number of processors (or separate computers) to perform a set of coordinated computations in parallel through a distributed computing infrastructure (e.g., cloud based infrastructure) for a specific advanced planning query.

The advanced planning and forecasting raw data may be a historical or forward-looking data input from at least one of an enterprise resource planning (ERP) program, a customer relationship management (CRM) program, a supplier relationship management (SRM) program, a material resource planning (MRP) program, a stock-keeping unit (SKU) database, and a user client device.

The method may also involve displaying the result of the advanced planning simulation cached in the edge cache server through a plug-in interface of an off-the-shelf spreadsheet program. The method may involve displaying the result of the advanced planning simulation cached in the edge cache server through a web-based spreadsheet program. The method may also involve accelerating the edge caching of the result by a toll route of data transmission. The method may additionally involve collecting the advanced planning and forecasting raw data by the one or more storage devices of the extensible computation engine and the one or more DBMS and storing the advanced planning and forecasting raw data in a columnar database table distributed across at least one of one or more memory storage devices of the extensible computation engine, the one or more DBMS, and the extensible memory cache.

The advanced planning simulation may involve modeling a historical or forward-looking profitability of the business enterprise using the advanced planning and forecasting raw data; modeling a demand and supply plan of the business enterprise using the advanced planning and forecasting raw data; modeling a capacity constraint of the business enterprise using the advanced planning and forecasting raw data; modeling a new product introduction by the business enterprise using the advanced planning and forecasting raw data; and extrapolating at least one of a weekly, a multi-week, a monthly, a multi-month, a yearly, and a multi-year financial forecast of the business enterprise using the advanced planning and forecasting raw data.

The advanced planning simulation may also involve balancing a demand criteria, a supply criteria, and a finance criteria of the business enterprise using the advanced planning and forecasting raw data. The advanced planning simulation may further involve modeling a what-if scenario at a demand forecasting stage and a supply forecasting stage of the business enterprise using the advanced planning and forecasting raw data; and modeling a financial scenario at a demand forecasting stage and a supply forecasting stage of the business enterprise using the advanced planning and forecasting raw data.

The methods, devices, and systems disclosed herein may be implemented in any means for achieving various aspects. Other features will be apparent from the accompanying drawings and from the detailed description that follows.

### BRIEF DESCRIPTION OF THE DRAWINGS

Example embodiments are illustrated by way of example and are not limited to the figures of the accompanying drawings, in which, like references indicate similar elements.

FIG. 1 illustrates a block diagram of a machine-implemented distributed computing system having a massively parallel processing architecture to facilitate advanced planning and forecasting, according to one or more embodiments.

FIG. 2A illustrates a plug-in interface of a machine-implemented system of the distributed computing system having the massively parallel processing architecture to facilitate advanced planning and forecasting, according to one or more embodiments.

FIG. 2B illustrates a web-based spreadsheet interface of a machine-implemented system of advanced planning and forecasting that can operably communicate with the distributed computing system having the massively parallel processing architecture to facilitate advanced planning and forecasting, according to one or more embodiments.

FIG. 3A illustrates a database table for storing advanced planning and forecasting raw data, according to one or more embodiments.

FIG. 3B illustrates a columnar database table for storing advanced planning and forecasting raw data, according to one or more embodiments.

FIG. 4 illustrates a flowchart diagram of a process flow for an example business enterprise, according to one or more embodiments.

FIG. 5 illustrates a home page interface associated with a machine-implemented advanced planning and forecasting system, according to one or more embodiments.

FIG. 6 illustrates an interface for searching and filtering planning items associated with a simulation performed by a machine-implemented advanced planning and forecasting system, according to one or more embodiments.

FIG. 7 illustrates an interface for initiating a forecasting action of a machine-implemented advanced planning and forecasting system, according to one or more embodiments.

FIG. 8A illustrates a demand and supply balancing dashboard associated with a machine-implemented advanced planning and forecasting system, according to one or more embodiments.

FIG. 8B illustrates another view of a demand and supply balancing dashboard associated with a machine-implemented advanced planning and forecasting system, according to one or more embodiments.

FIG. 9 illustrates a manufacturing capability dashboard associated with a machine-implemented advanced planning and forecasting system, according to one or more embodiments.

FIG. 10 illustrates a demand planning dashboard associated with a machine-implemented advanced planning and forecasting system, according to one or more embodiments.

FIG. 11 illustrates a scenario demand planning dashboard associated with a machine-implemented advanced planning and forecasting system, according to one or more embodiments.

FIG. 12 illustrates a rough cut capacity planning (RCCP) dashboard associated with a machine-implemented advanced planning and forecasting system, according to one or more embodiments.

FIG. 13 is a flowchart illustrating the machine-implemented method of advanced planning and forecasting of a business enterprise, according to one or more embodiments.

FIG. 14 is a flowchart illustrating the machine-implemented method of advanced planning and forecasting of a business enterprise, according to one or more embodiments.

FIG. 15 is a network view of a distributed computing environment communicating with a mobile device having a geospatially relevant supply chain module through a network, according to one or more embodiments.

FIG. 16 is an exploded view of a geospatially relevant supply chain module of FIG. 15, according to one or more embodiments.

FIG. 17 is user interface view of the mobile device of FIG. 15 that embodies operations performed by the geospatially relevant supply chain module of FIG. 15 in communication with the distributed computing environment, according to one or more embodiments.

FIG. 18 is an electronics and computer industry supply chain view leveraging a distributed computing environment, according to one embodiment.

FIG. 19 is a simulation view of the electronics and computer industry supply chain view leveraging the distributed computing environment, according to one embodiment.

Other features of the present embodiments will be apparent from the accompanying drawings and from the detailed description that follows.

### DETAILED DESCRIPTION

Disclosed are methods and systems of advanced planning in a rapidly changing and high-technology electronic and computer industry supply chain through massively parallel processing of data using a distributed computing environment. Although the present embodiments have been described with reference to specific example embodiments, it will be evident that various modifications and changes may be made to these embodiments without departing from the broader spirit and scope of the various embodiments. It should be understood by one of ordinary skill in the art that the terms “application(s),” “program(s),” “software,” “software code,” “sub-program(s),” “module(s),” and “block(s)” are industry terms that refer to computing instructions stored in a memory or storage device of a processing device and executable by a processor of the processing device.

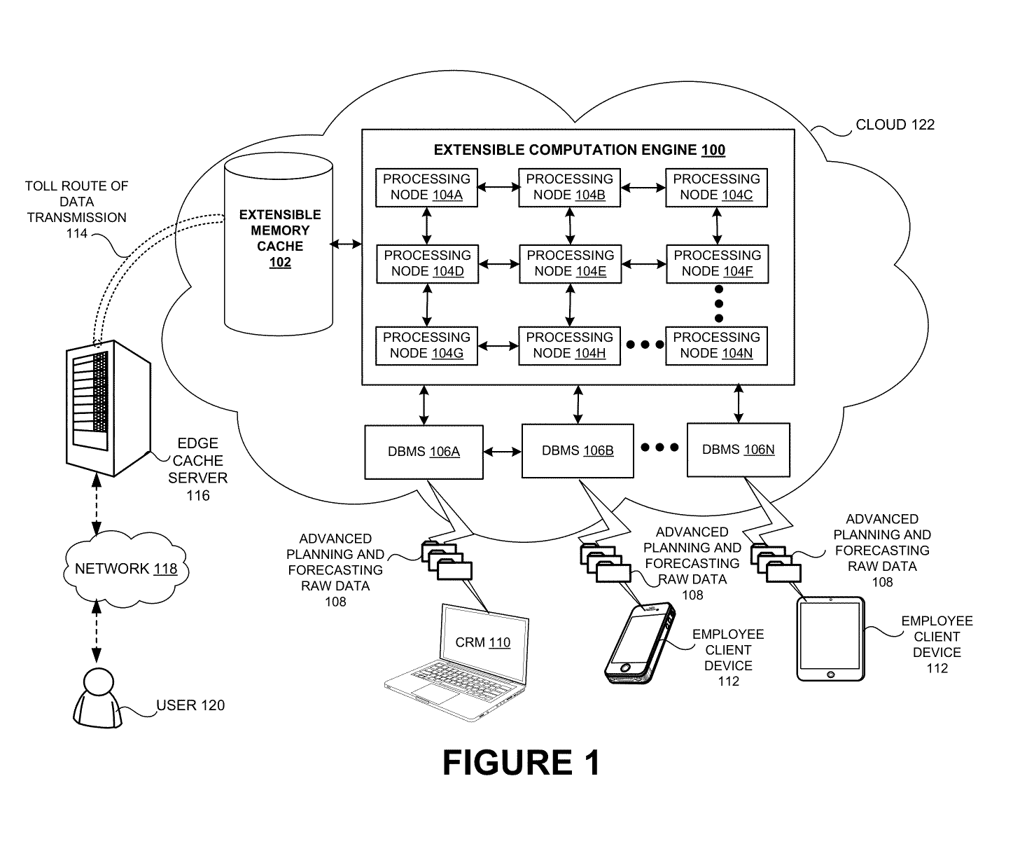

Reference is now made to FIG. 1, which illustrates a block diagram of a machine-implemented distributed computing system having a massively parallel processing architecture to facilitate advanced planning and forecasting, according to one or more embodiments. In one embodiment, the system may include an extensible computation engine 100 configured to perform an advanced planning simulation. The extensible computation engine 100 may include a number of processing nodes 104A-104N that are communicatively coupled to one another. The processing nodes 104A-104N may include one or more computing devices, for example a single server incorporating a processing unit or a cluster of servers incorporating processing units therein. In one embodiment, the processing nodes 104A-104N may include master and slave processing nodes. All the master processing nodes and slave processing nodes may reside on the same machine (e.g. a single-node installation) or they may be distributed amongst a cluster of machines. It should be understood by one of ordinary skill in the art that various types of servers and processing units may be used to carry out floating point calculations associated with the advanced planning simulation. The processing nodes 104A-104N may also include a memory. In one embodiment, the memory associated with a processing node need not be substantial in size, and in some examples may be 8 GB or 16 GB. In one embodiment, the extensible computation engine 100 may be located in a cloud computing environment, for example cloud 122. The cloud 122 may be accessed through a network 118 using protocols known by those skilled in the art. In one or more embodiments, the network 118 may be a Wide Area Network (WAN), a Local Area Network (LAN), etc. In some examples, the extensible computation engine 100 may be implemented using a framework for the distributed processing of large data sets across clusters of computers, for example using the Apache Hadoop® software library. Additionally, a data warehouse system, for example Apache Hive®, may be implemented to facilitate easy data summarization, ad-hoc queries, and the analysis of large datasets.

In one embodiment, the extensible computation engine 100 may be configured to collect an advanced planning and forecasting raw data 108. The extensible computation engine 100 may be associated with one or more storage devices configured to store the advanced planning and forecasting raw data 108 in a database table. In some examples, the database table may be a columnar database table 300B, as will be described below. The advanced planning and forecasting raw data 108 may be used by the extensible computation engine 100 to conduct the advanced planning simulation. It may be advantageous to use the extensible computation engine 100 instead of a local computing device for large data sets for a variety of reasons, such as to utilize the processing power and/or the memory of the extensible computation engine 100. It may also be advantageous to use one extensible computation engine 100 across a number of clients from different business enterprises to utilize an economy of scale. Processing nodes 104A-104N may be added to the extensible computation engine 100 as needed.

The extensible computation engine 100 may be communicatively coupled to an extensible memory cache 102. The extensible memory cache 102 may be configured to cache a result of the advanced planning simulation. By caching the results of advanced planning simulations and other requests from users, answers to queries may be delivered in a faster, more efficient manner. In one embodiment, the extensible memory cache 102 may be a computing device, for example a server, incorporating a storage unit, for example flash memory, therein. In one embodiment, the extensible memory cache 102 may be a storage device, for example a network-enabled hard drive. In some examples the extensible memory cache 102 may have a multi-terabyte capacity, for example 1-4 TB. It will be understood that various capacities may be used depending on the scale of calculations to be conducted. In one embodiment, the extensible memory cache 102 may be configured to store the advanced planning and forecasting raw data 108 in a database table. In some examples, the database table may be a columnar database table 300B. In one embodiment, the extensible memory cache 102 may be located in the cloud 122. In some examples, the extensible memory cache 102 may use a data management system, for example Terracotta BigMemory®, to implement a distributed memory system across multiple servers with minimal performance hits. In one embodiment, the extensible computation engine 100 and/or the extensible memory cache 102 may use a fault-tolerant file system, for example the Hadoop Distributed File System (HDFS).

The extensible computation engine 100 may also be communicatively coupled to one or more database management systems (DBMS) 106A-106N. The DBMS 106A-106N may be a relational database management system (RDBMS) and/or a NoSQL engine. The DBMS may be configured to collect and/or aggregate the advanced planning and forecasting raw data 108. The DBMS 106A-106N may be configured to obtain the advanced planning and forecasting raw data 108 from a client device, for example a customer relationship management program 110 or an employee client device 112. The DBMS 106A-106N may be configured to forward the advanced planning and forecasting raw data 108 to the extensible computation engine 100. In one embodiment, the DBMS 106A-106N may be configured to store the advanced planning and forecasting raw data 108 in a database table. In some examples, the database table may be a columnar database table 300B. In one embodiment, the DBMS may be located in the cloud 122. In one embodiment, the DBMS 106A-106N may be implemented using MySQL or Oracle.

The extensible memory cache 102 may be communicatively coupled to an edge cache server 116. In one embodiment, a number of edge cache servers 116 may be located at different geographical points. The edge cache server 116 may be configured to edge cache the result of the advanced planning simulation near a geographical point of origin of the client device. In one embodiment, the edge caching of the result of the advanced planning simulation may be accelerated by a toll route of data transmission 114. The toll route of data transmission 114 may be implemented by any known network traffic management technique, such as traffic shaping, quality of services (QoS) policies, a differentiated services architecture, or an integrated services architecture. In one embodiment, data packets associated may be given priority based on a fee paid to an Internet service provider. It will be understood that other mechanisms for prioritizing packet delivery may be used to implement the toll route of data transmission 114. The edge cache server 116 may be configured to communicate the result of the advanced planning simulation to a user 120 through the network 118. Caching results in geographical proximity to the origin of a query may reduce latency in delivering the result to the user 120. In one embodiment, the result of the advanced planning simulation cached in the edge cache server 116 may be displayed through a plug-in interface of an off-the-shelf spreadsheet program, as will be described below. In another embodiment, the result of the advanced planning simulation cached in the edge cache server 116 may be displayed through a web-based spreadsheet program, as will be described below.

The edge cache server 116 and/or the extensible computation engine 100 may be configured to respond to the user 120 or users based on a profile of the user 120 or users. For example, a sales account executive of the business enterprise would be provided with a response for sale related queries such as projected target sales, items sold, etc. In another example, a vice president of sales of the business enterprise would be provided with a response for the queries on plans, projected sales, target sales and the like. Each of the user(s) 120 may be provided with a profile and the edge cache server 116 and/or the extensible computation engine 100 may be configured to respond to each of the user(s) 120 based on the user profile. Each of the user(s) 120, based on the profile, may be provided with options such as access to files, type of user interfaces and other report-generating options. It will be understood that a different computing device may be implemented to interact with the user(s) 120.

The advanced planning and forecasting raw data 108 may be a historical or forward-looking data input from an enterprise resource planning (ERP) program, a customer relationship management (CRM) program 110, a supplier relationship management (SRM) program, a material resource planning (MRP) program, a stock-keeping unit (SKU) database, and/or a user client device 112 (also referred to as an employee client device). For example, the advanced planning and forecasting raw data 108 may be obtained from SAP, Salesforce.com, and/or Big Machines, and then normalized. In one embodiment, the advanced planning and forecasting raw data 108 may be real-time data. In one embodiment, data from ERP, CRM, SRM, MRP, and/or SKU systems may be aggregated into a single, unified platform for strategic business planning. In one embodiment, the advanced planning and forecasting raw data 108 may be imported to any of the extensible computation engine 100, the extensible memory cache 102, and the DBMS 106A-106N through an interface of an advanced planning and forecasting application installed on the user client device 112. In one embodiment, the advanced planning and forecasting raw data 108 may be imported from the DBMS 106A-106N to a data warehouse system, for example Apache Hive®, of the extensible computation engine 100 by using commonly available tools known by those skilled in the art, for example Apache Sgoop™. In one embodiment, the advanced planning and forecasting raw data 108 may be exported from the extensible computation engine 100 back to the DBMS 106A-106N by using commonly available tools known by those skilled in the art, for example HadoopMapReduce.

The advanced planning simulation may be performed by one or more processing nodes 104A-104N of the extensible computation engine 100 using the advanced planning and forecasting raw data 108. The advanced planning simulation may include modeling a historical or forward-looking profitability of the business enterprise using the advanced planning and forecasting raw data 108. The advanced planning simulation may further include modeling a demand and supply plan of the business enterprise using the advanced planning and forecasting raw data 108. The advanced planning simulation may additionally include modeling a capacity constraint of the business enterprise using the advanced planning and forecasting raw data 108. The advanced planning simulation may include modeling a new product introduction by the business enterprise using the advanced planning and forecasting raw data 108. The advanced planning simulation may also include extrapolating at least one of a weekly, a multi-week, a monthly, a multi-month, a yearly, and a multi-year financial forecast of the business enterprise using the advanced planning and forecasting raw data 108.

The advanced planning simulation may also include balancing a demand criteria, a supply criteria, and a finance criteria of the business enterprise using the advanced planning and forecasting raw data 108. The advanced planning simulation may additionally include modeling a what-if scenario at a demand forecasting stage and a supply forecasting stage of the business enterprise using the advanced planning and forecasting raw data 108. The advanced planning simulation may also include modeling a financial scenario at a demand forecasting stage and a supply forecasting stage of the business enterprise using the advanced planning and forecasting raw data 108. The modeling may include taking into account the import and export controls that are a characteristic of the business enterprise.

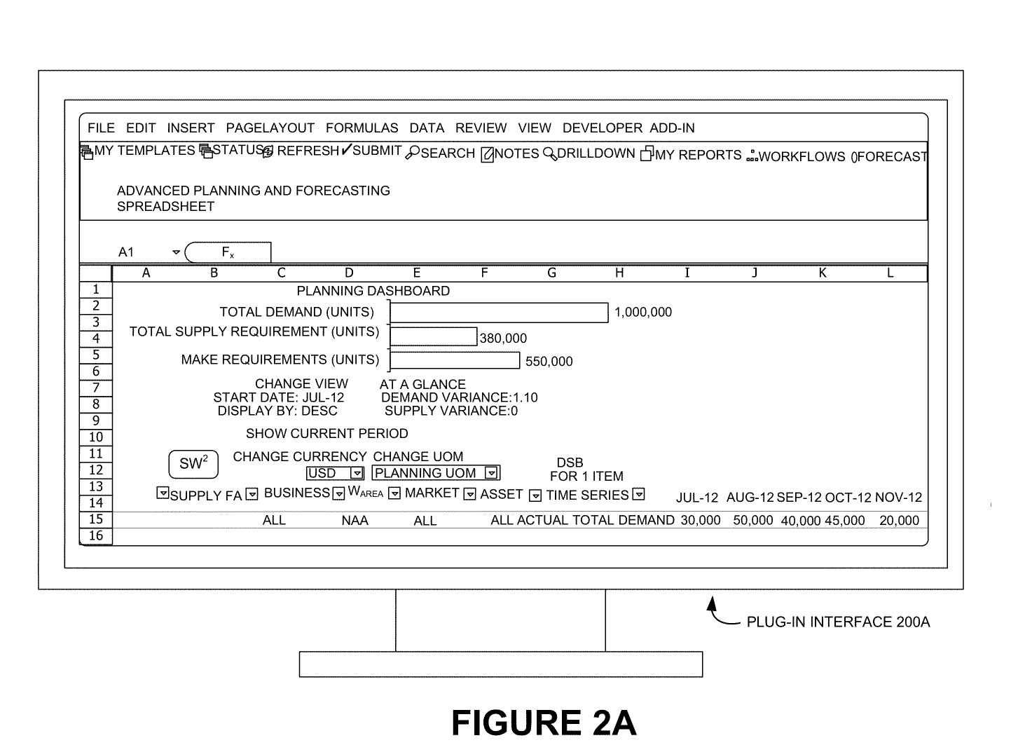

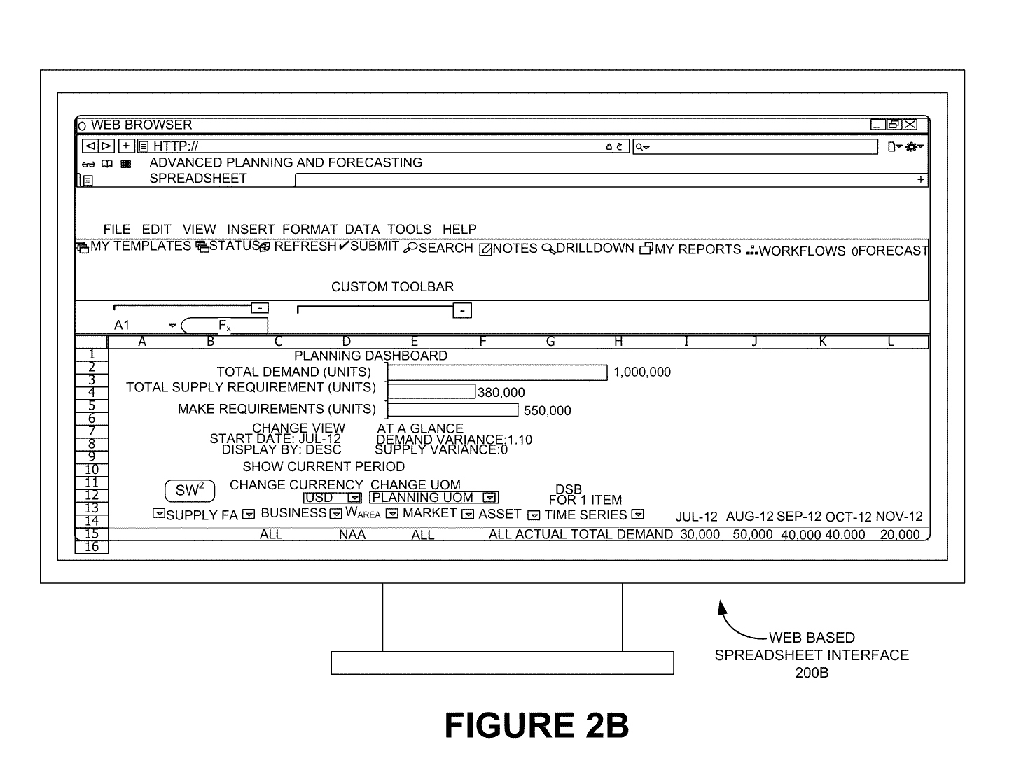

Reference is now made to FIG. 2A, which illustrates a plug-in interface 200A of a machine-implemented system of advanced planning and forecasting. The plug-in interface 200A may be implemented for use with a conventional, off-the-shelf spreadsheet application, for example Microsoft Excel. The spreadsheet application may be used to display the result of the advanced planning simulation in a user-readable interface as will be described below. In one embodiment, the extensible computation engine 100 may perform the advanced planning simulation, and send the result to the plug-in interface 200A for review by the user 120. In some examples, the spreadsheet application may perform some calculations associated with the advanced planning simulation.

Reference is now made to FIG. 2B, which illustrates a web-based spreadsheet interface 200B of a machine-implemented system of advanced planning and forecasting, according to one or more embodiments. The web-based spreadsheet interface 200B may be displayed to a user 120 via a web browser. The web-based spreadsheet interface 200B may be implemented by programming languages known in the art, for example HTML, Javascript, or Ruby on Rails. In some examples, the web-based spreadsheet interface 200B may be implemented to appear similar in look and feel relative to the plug-in interface 200A.

In one or more embodiments, the plug-in interface 200A or the web-based spreadsheet interface 200B may be any of, but not limited to management interface, search entry navigation interface, etc. In one or more embodiments, the plug-in interface 200A or the web-based spreadsheet interface 200B may be configured to display advanced planning and forecasting parameters, for example advanced planning and forecasting raw data 108, advanced planning simulation parameters, advanced planning and forecasting templates. In one or more embodiments, based on the advanced planning simulation parameters, the extensible computation engine 100 may be configured to conduct the advanced planning simulation. After each advanced planning simulation is conducted, the plug-in interface 200A or the web-based spreadsheet interface 200B may be configured to only update the elements that change as compared to the previous time the advanced planning simulation was run.

In one or more embodiments, the plug-in interface 200A or the web-based spreadsheet interface 200B may also include an administrative user interface designed to carry out various functions. In one or more embodiments, the functions may include, but are not limited to, sending notification e-mails, creating a backup of assignments and sending the assignments, assigning the access to a portion of the application of advanced planning and forecasting, etc. In one or more embodiments, the plug-in interface 200A or the web-based spreadsheet interface 200B may include options for the user 120 to receive an email alert and/or a Short Message Service (SMS) based on timing or event criteria defined by the user 120.

In one or more embodiments, the plug-in interface 200A or the web-based spreadsheet interface 200B may include a template manager and worksheet generators which may be combination frameworks. In one or more embodiments, templates may be the views which are used to view the data within worksheet/spreadsheet. In one or more embodiments, the spreadsheets/worksheets may be the instances of the templates. In one or more embodiments, the user(s) 120 may manage the views, the order of time series that appear in the templates, etc.

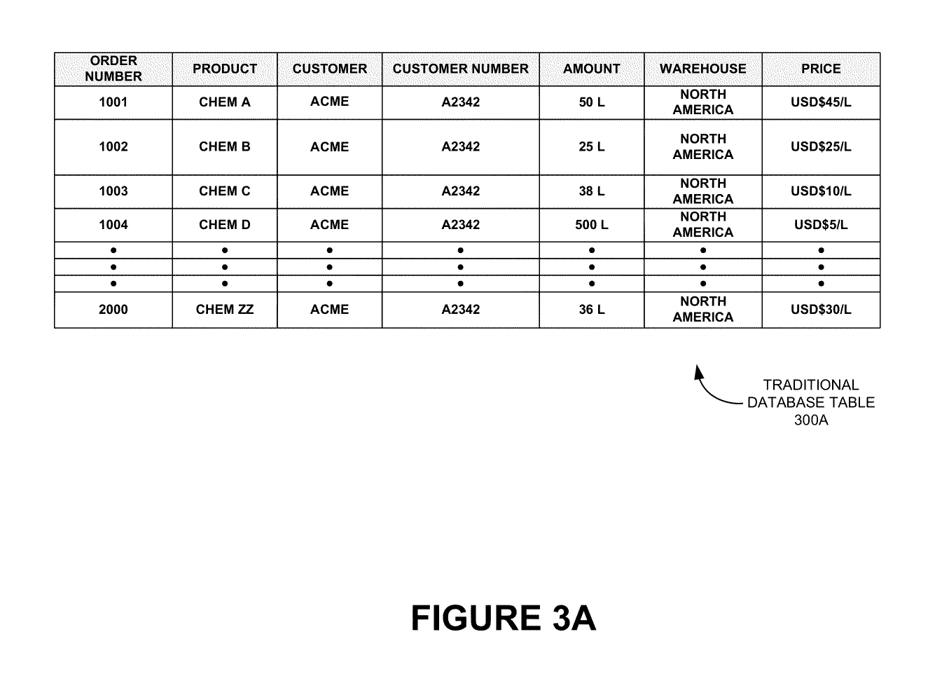

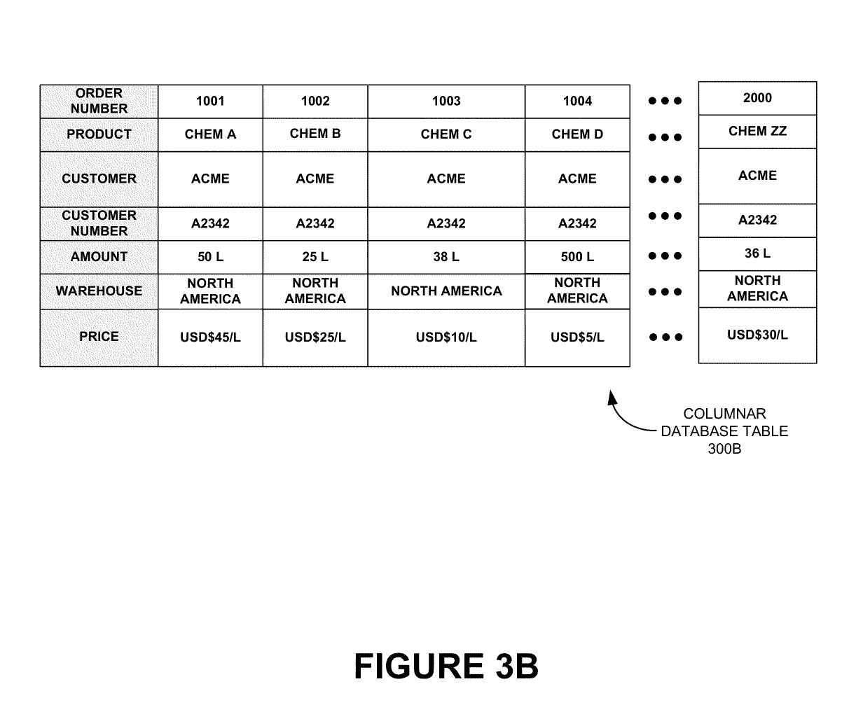

Reference is now made to FIG. 3A, which illustrates a traditional database table 300A for storing advanced planning and forecasting raw data, according to one or more embodiments. In one embodiment, the traditional database table 300A may include entries relevant to the business enterprise, such as order number, product, customer, customer number, amount, warehouse and/or price. A database table for storing advanced planning and forecasting raw data may contain billions of entries. In one embodiment, the data in the traditional database table 300A may be normalized. Additionally, data may be stored in a record by record label structure.

Reference is now made to FIG. 3B, which illustrates a columnar database table 300B for storing advanced planning and forecasting raw data, according to one or more embodiments. In one embodiment, the columnar database table 300B may include entries relevant to the business enterprise, such as order number, product, customer, customer number, amount, warehouse and/or price. A columnar database table 300B may be a transpose of the traditional database table 300A. A columnar database table 300B may offer performance improvements for advanced planning and forecasting calculations because columnar technology is faster in querying the same item across many rows of data. Further, a column-oriented layout may permit columns that are not accessed in a query to be skipped. Additionally, a columnar database table 300B may offer reduced storage requirements because columnar databases rarely use user-defined indexes. In one embodiment, the columnar database table 300B may be implemented in a data warehouse system, for example Apache Hive®.

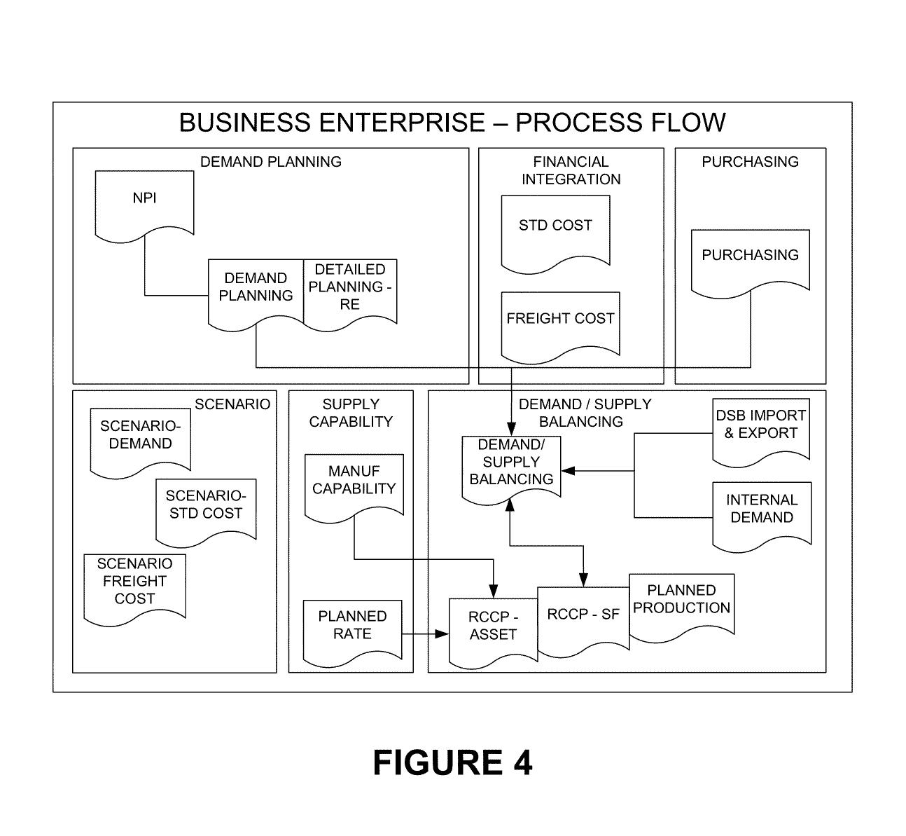

Reference is now made to FIG. 4, which illustrates a flowchart diagram of a process flow for an example business enterprise. In one embodiment, the process flow for a business enterprise may include demand planning, financial integration, purchasing analysis, scenario analysis, supply capability analysis, and demand/supply balancing. The advanced planning simulation may be implemented in light of the process flow for the business enterprise. For example, demand criteria and supply criteria may be specific to a particular business enterprise, thereby necessitating a specialized business process flow involving specialized calculations. Thus, there is a need for a system customizable to perform large-scale computations based on specialized business process flows.

Demand planning may be initiated in preparation of a new product introduction (NPI). The demand plan may be based on one or more predefined factors. Examples of the predefined factors may include, but are not limited to, sales, finance, product marketing and strategic management. For example, the demand plan may be created in the cloud 122 based on a demand forecasting algorithm that considers multi-party input in client-side visualizations of a certain aspect of the demand plan appropriate to a demand-side stakeholder based on a rules-based algorithm that considers a demand-side access privilege and a demand-side role of the demand-side stakeholder. A certain aspect may be a segmented view of the demand plan depending on a role and/or responsibility of a stakeholder to the enterprise. The factors and aspects may be aggregated to obtain a demand criteria to be used in demand/supply balancing. The advanced planning and forecasting raw data 108 may include the demand criteria, and the extensible computation engine 100 may perform the advanced planning simulation using the advanced planning and forecasting raw data 108 with the demand criteria incorporated therein.

In a business enterprise, there may be demand criteria due to the nature of the industry. An internal demand may be a demand within, for example within a business unit of, the business enterprise. In some examples, there may be international demands when the business enterprise is located in multiple countries. The international demands may be categorized as import and export demands. The number of types of demands may be aggregated to produce a total demand to be used for demand/supply balancing.

A supply plan may be based on one or more predefined factors. Examples of the predefined factors may include, but are not limited to, raw material providers and logistics. For example, the supply plan may be created in the cloud 122 based on a supply-forecasting algorithm that considers multi-party input in client-side visualizations of a particular aspect of the supply plan appropriate to a supply-side stakeholder based on a rules-based algorithm that considers a supply-side access privilege and a supply-side role of the supply-side stakeholder. A particular aspect may be a segmented view of the supply plan depending on a role and/or responsibility of a stakeholder to the business enterprise.

The total supply may be balanced with the total demand to calculate a make requirement. In one embodiment, supply families may be prioritized in a multi-level balancing implementation. A dependent demand may be created when a supply unit cannot meet the make requirement. In one embodiment, the demand and supply may be balanced to produce a safety stock. In one embodiment, the demand/supply balancing may be performed using finance criteria such as standard costs and freight costs. In one embodiment, the demand/supply balancing may be performed using purchasing metrics.

There may also be a supply criteria that may be balanced with the demand criteria. The supply criteria may include a supply capability analysis, which may involve analyzing capacity constraints, the manufacturability and the planned rate. Additionally, the supply may include a number of supply families. The supply families may be separate business units capable of producing an asset. The supply criteria may be aggregated to produce a total supply requirement. The advanced planning and forecasting raw data 108 may include the supply criteria, and the extensible computation engine 100 may perform the advanced planning simulation using the advanced planning and forecasting raw data 108 with the supply criteria incorporated therein.

In one embodiment, the demand/supply balancing may include a resource leveling analysis to examine unbalanced use of resources over time. It may be advantageous to perform resource leveling to resolve over-allocations or conflicts. A rough cut capacity planning (RCCP) profile may be used in resource leveling to plan the requirements of one or more resources. The resources may include, but are not limited to, work center capabilities, materials, production resources/tools, and costs. The resource leveling analysis may involve performing an advanced planning simulation by the extensible computation engine 100 using advanced planning and forecasting raw data 108 incorporating resource leveling factors therein. The resource leveling factors may be data related to the one or more resources and their requirements.

Scenario planning may include short term or long term demand/supply planning. A scenario may be a production-safe sandbox where different operational and financial options can be exercised and discussed. Scenario planning may include a demand analysis, which may involve determining effects of adjustments in price on margins. Scenario planning may further include a standard cost analysis, which may involve determining effects of adjustments in standard costs on margins. Scenario planning may additionally include a freight cost analysis, which may involve determining effects of changes in freight costs on margins. In some examples, scenarios may be saved in local memory, the extensible memory cache 102, or another storage device for future reference. In one example, a user may create a scenario involving changing costs, revenue and/or price to see the effect on the plan. In one embodiment, the results of multiple scenarios may be displayed simultaneously in a single graphical representation. Scenario planning may involve performing an advanced planning simulation using the big data computational engine 100, wherein the advanced planning and forecasting raw data 108 used to perform the advanced planning simulation incorporates factors relevant to the scenario.

In one embodiment, different stages of advanced planning and forecasting may be conducted in a month. In the first week of the month, a sales & marketing team associated with a business enterprise may forecast data. In the second and third week of the month, demand planning may be conducted. In the fourth week of the month, demand/supply balancing may be conducted.

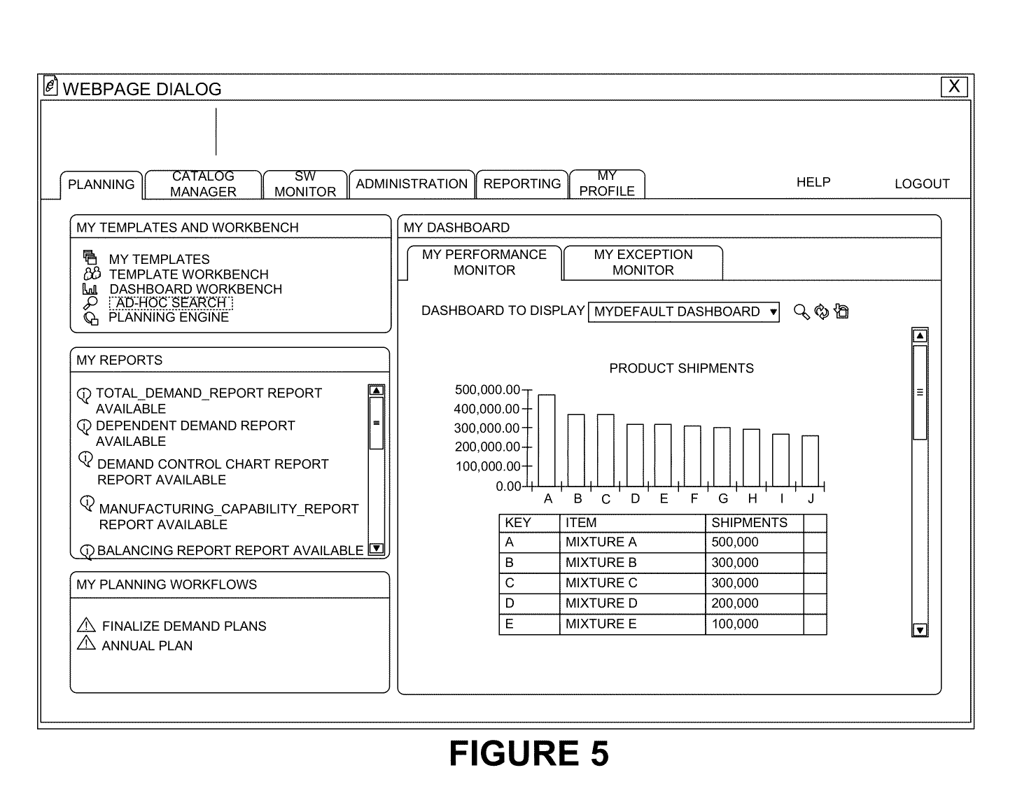

Reference is now made to FIG. 5, which illustrates a home page interface associated with a machine-implemented advanced planning and forecasting system. The home page interface may include a number of tabs, such as planning, catalog manager, monitor, administration, reporting and profile tabs. The planning tab may include an interface displaying links to templates, reports, and workflows. Planning templates may be accessed, created, or managed through the planning tab interface. In some examples, a first user may assign a planning template to a second user. User(s) 120 may also access reports through the planning tab interface. In addition, user(s) 120 may be alerted to needed actions through workflow alerts displayed in the planning tab interface. Additionally, a portion of the planning tab interface may be used to display graphical representations of different personalized dashboards relating to exceptions and performance planning, for example a demand and supply balancing dashboard. The personalized dashboards may be graphical representations of the results of various types of advanced planning simulations performed by the extensible computation engine 100. In some examples, a first user may assign a dashboard to a second user. In one embodiment, an ad-hoc search link may direct a user to an interface in which user(s) 120 may select planning items, associate them with a template, and download them.

In one or more embodiments, the catalog manager tab may include an interface in which the user(s) 120 can manage data within the application. In one or more embodiments, the catalog manager may assist in mapping the data. The monitor tab may include an interface in which user(s) 120 can monitor job queues to check on the processing of overrides. The catalog manager may include an interface in which a user can search and edit planning items, create and maintain filters, create temporary items and product/market relationships, and perform mass updates. The administration tab may include an interface in which user(s) 120 can perform administrative tasks. The profile tab may include an interface in which user(s) can adjust personal settings, for example passwords.

Additionally, the reporting tab may include an interface to allow a user 120 to view, copy, and/or edit various kinds of reports, for example market reports, sales reports, or standard reports. In one embodiment, the reporting interface may allow a user to access a multi-panel report. The multi-panel report may include retail data, wholesale data, production data, stock data, and/or measure data. The data may be actual data or forecast data. The reports may include public, private, and administrative reports. The data for the multi-panel report may be obtained by performing an advanced planning simulation using the extensible computation engine 100.

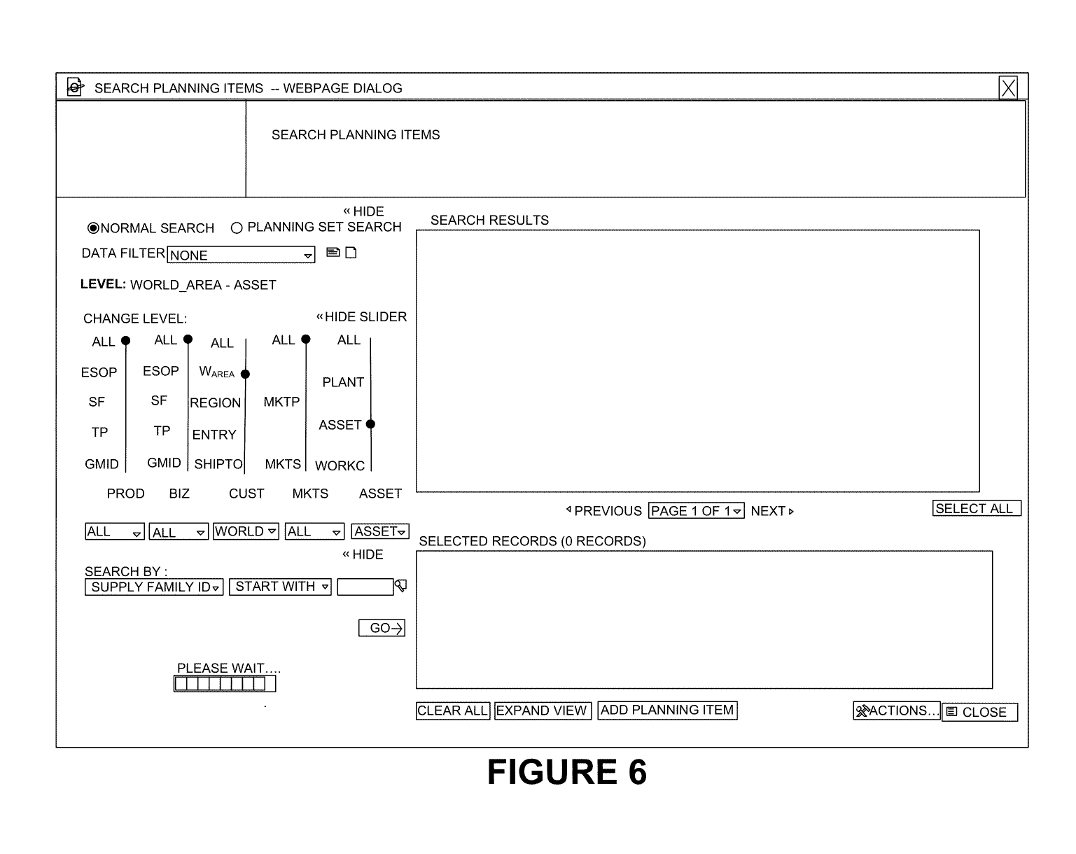

Reference is now made to FIG. 6, which illustrates an interface for searching planning items associated with a machine-implemented advanced planning and forecasting system. The search planning items interface may be configured to present options to a user 120 based on the user's 120 access level. For example, a user 120 in a certain geographical market may only be presented options related to that geographical market. The search planning items interface may be configured to allow the user 120 to access various kinds of data associated with advanced planning and forecasting, for example forecast data or actuals data. The search planning items interface may include one or more level selection interfaces, for example sliders. In some examples, the level selection interfaces may represent hierarchies of data. Additionally, the search planning items interface may include a data filter interface in which the user 120 may search for a particular type of data. In some examples, the user 120 may be presented with an interface to search data sets by additional criteria or attributes. After specifying a search criteria, the user 120 may be presented with search results containing records that may be chosen for display by the user 120. The search planning items interface may communicate with the edge cache server 116, the extensible memory cache 102, and/or the extensible computation engine 100 to search for planning items.

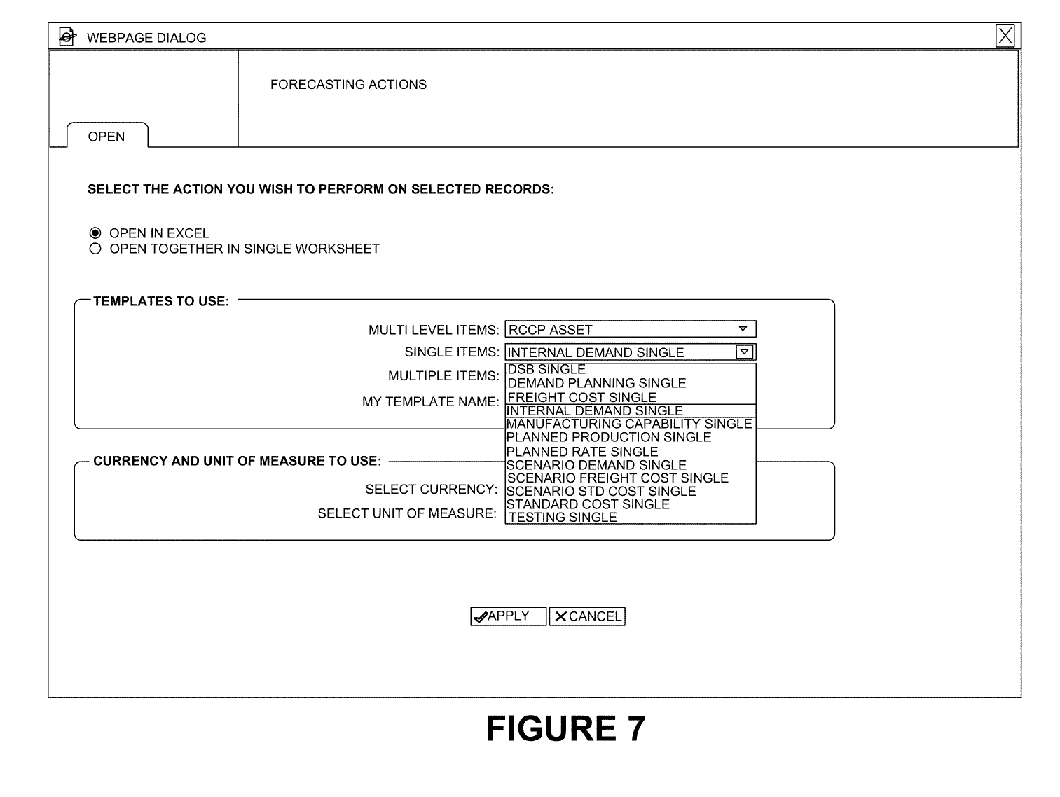

Reference is now made to FIG. 7, which illustrates an interface for initiating a forecasting action of a machine-implemented advanced planning and forecasting system. A forecasting action may be a type of advanced planning simulation that may be performed by the extensible computation engine 100. The forecasting action may be performed to achieve a simulation objective such as reducing cost or reducing time. A number of simulation objectives may be chosen, as will be appreciated by one skilled in the art. The forecasting action may be performed using templates chosen by the user 120. The forecasting action interface may provide options for the user 120 to present the result of the forecasting action in a spreadsheet program, for example Microsoft Excel, and/or present the result of the forecasting action in a single worksheet.

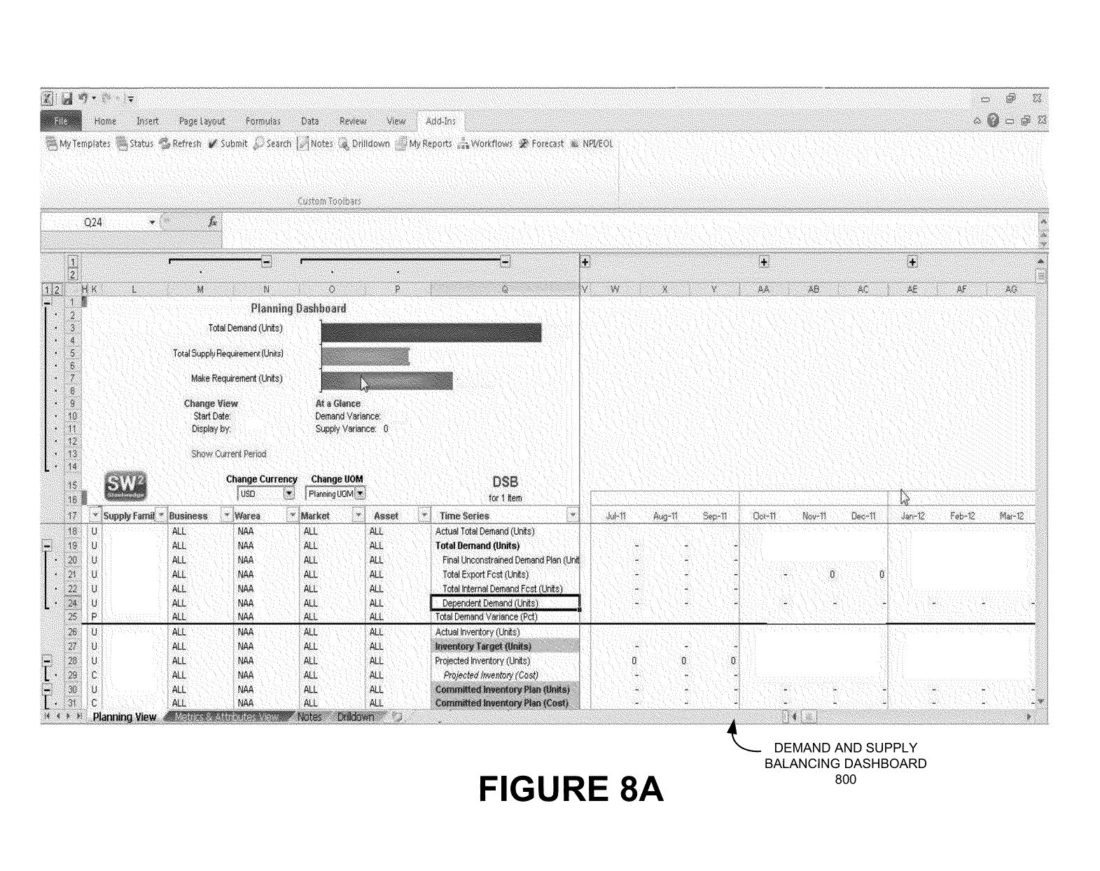

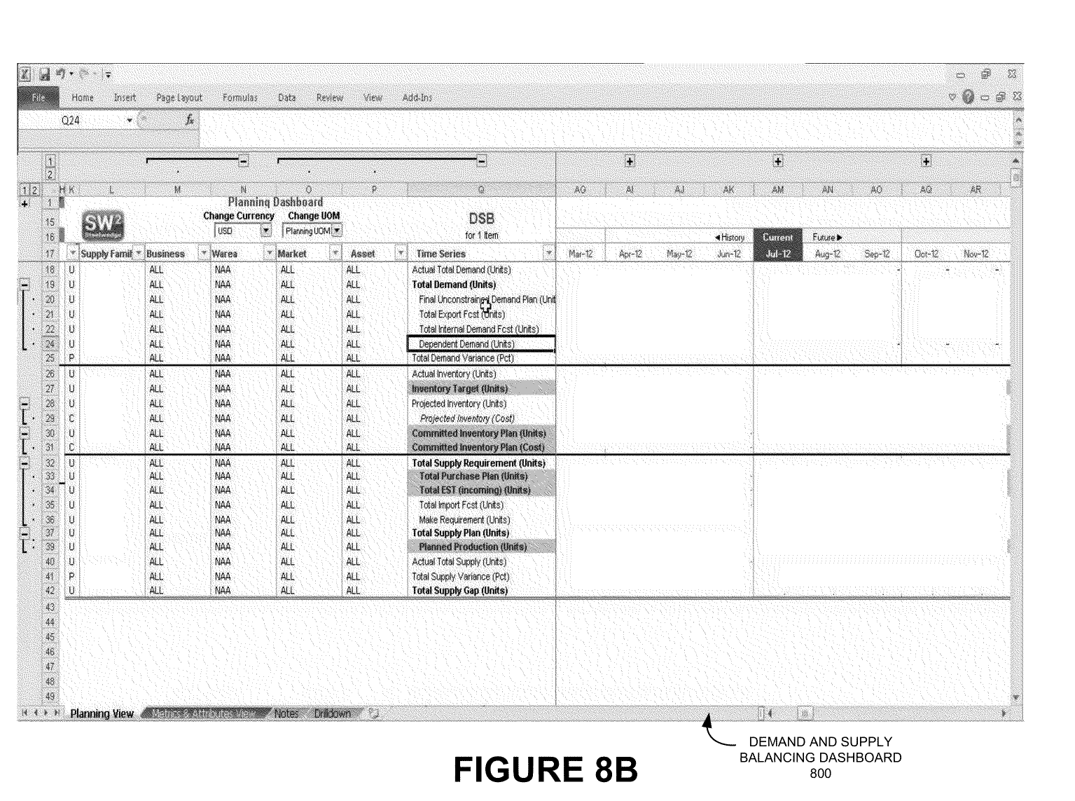

Reference is now made to FIGS. 8A and 8B, which illustrate a demand and supply balancing dashboard 800 associated with a machine-implemented advanced planning and forecasting system. The demand and supply balancing dashboard 800 may include a planning dashboard providing a graphical representation of any of the advanced planning and forecasting raw data 108 and the advanced planning simulation results. The demand and supply balancing dashboard 800 may provide a user-readable representation of the advanced planning and forecasting raw data 108 and/or the advanced planning simulation results. In one embodiment, the demand and supply balancing dashboard 800 may display data relating to the demand planning portion and/or the demand/supply balancing portion of the process flow shown in FIG. 4. The demand and supply balancing dashboard 800 may be communicatively coupled to a database associated with the DBMS 106A-106N, the extensible computation engine 100 or the extensible memory cache 102. The demand and supply balancing dashboard 800 may include supply family data, business data, area data, market data, asset data, and time series data. The time series data may include parameters such as total demand, total supply requirement, total supply plan and total supply gap. Data in the demand and supply balancing dashboard 800 may be modified by a user, for example an account manager, to send a result back to the database associated with the DBMS 106A-106N, the extensible computation engine 100 and/or the extensible memory cache 102.

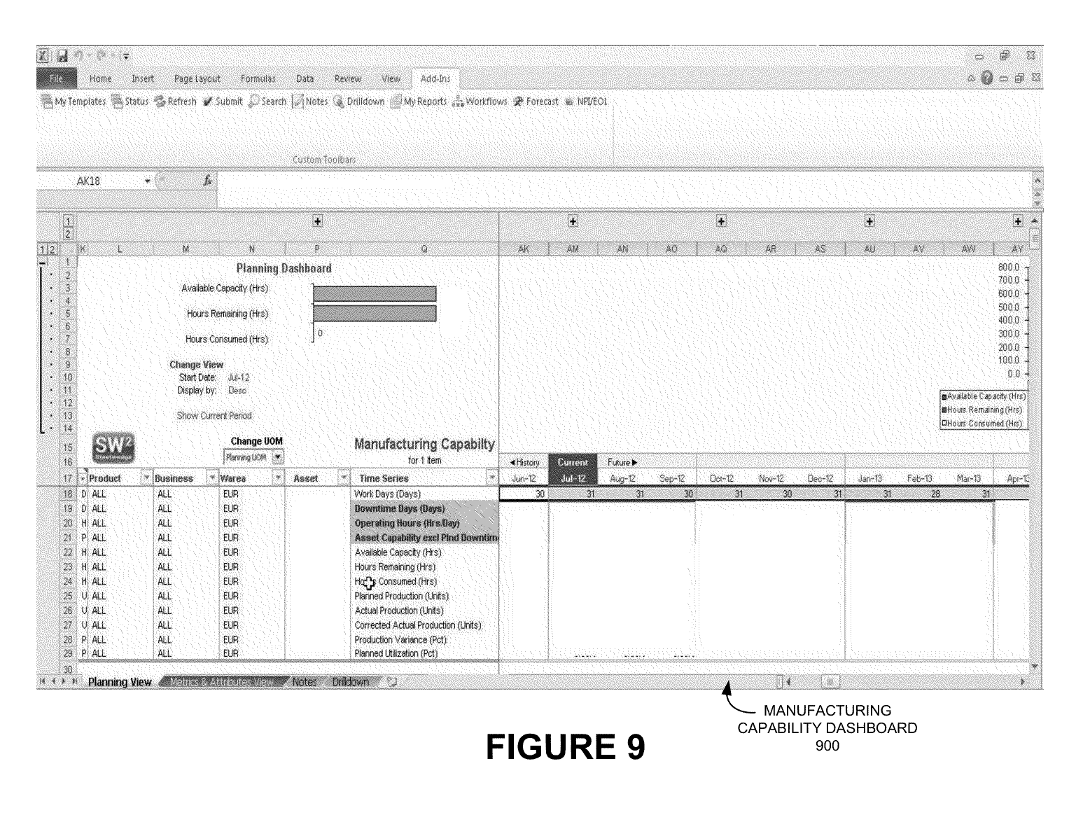

Reference is now made to FIG. 9, which illustrates a manufacturing capability dashboard 900 associated with a machine-implemented advanced planning and forecasting system. The manufacturing capability dashboard 900 may include a planning dashboard providing a graphical representation of the advanced planning and forecasting raw data 108 and/or the advanced planning simulation results. The manufacturing capability dashboard 900 may provide a user-readable representation of any of the advanced planning and forecasting raw data 108 and the advanced planning simulation results. In one embodiment, the manufacturing capability dashboard 900 may display data relating to the supply capability portion of the process flow shown in FIG. 4. The manufacturing capability dashboard 900 may be communicatively coupled to a database associated with the DBMS 106A-106N, the extensible computation engine 100 or the extensible memory cache 102. The manufacturing capability dashboard 900 may include product data, business data, area data, market data, asset data, and time series data. The time series data may include parameters such as work days, downtime days, operating hours, asset capability and available capacity. Data in the manufacturing capability dashboard 900 may be modified by a user, for example an account manager, to send a result back to the database associated with the DBMS 106A-106N, the extensible computation engine 100 or the extensible memory cache 102.

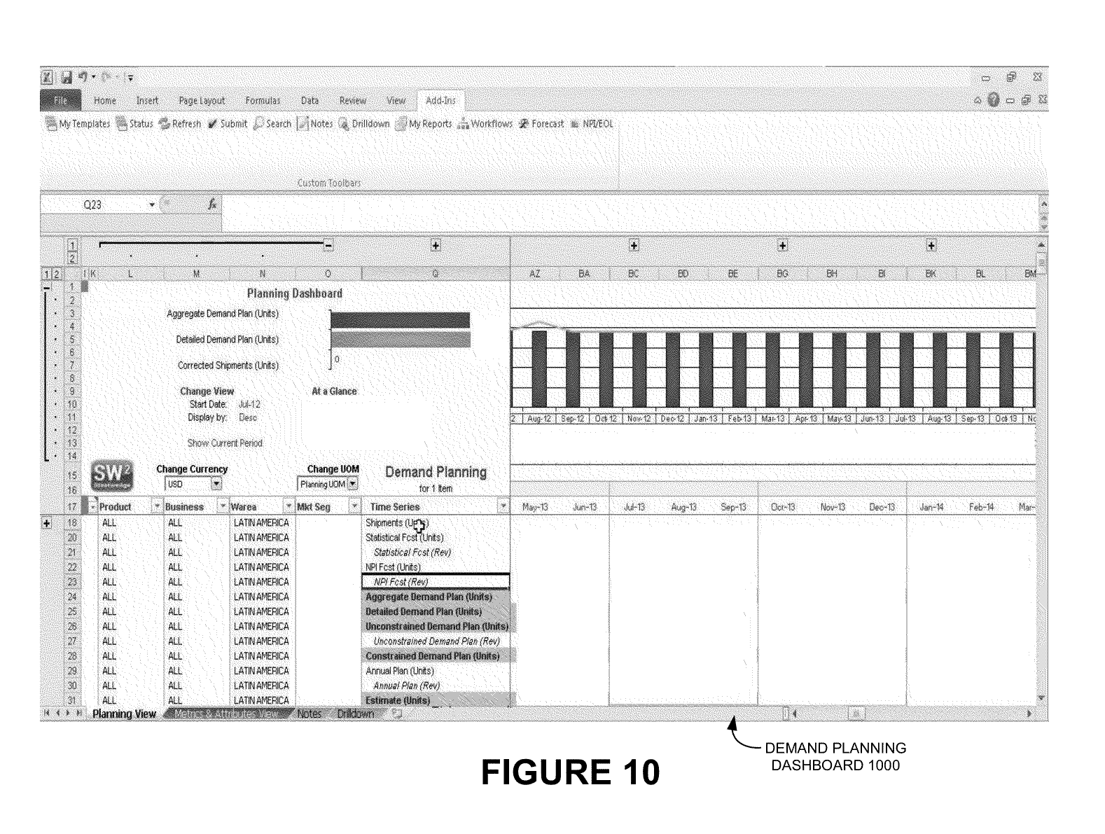

Reference is now made to FIG. 10, which illustrates a demand planning dashboard 1000 associated with a machine-implemented advanced planning and forecasting system. The demand planning dashboard 1000 may provide a user-readable representation of the advanced planning and forecasting raw data 108 and/or the advanced planning simulation results. In one embodiment, the demand planning dashboard 1000 may display data relating to the demand planning portion of the process flow shown in FIG. 4. The demand planning dashboard 1000 may be communicatively coupled to a database associated with the DBMS 106A-106N, the extensible computation engine 100 or the extensible memory cache 102. The demand planning dashboard 1000 may include family data, customer data, source data and time series data. The time series data may include parameters such as aggregate demand plan, detailed demand plan, unconstrained demand plan, and constrained demand plan. The demand planning dashboard 1000 may also include a planning dashboard that may display a graphical representation of an aggregate demand plan, a detailed demand plan and a corrected shipments metric. The demand planning dashboard 1000 may also include a graphical representation of the time series data. Data in the demand planning dashboard 1000 may be modified by a user 120, for example an account manager, to send a result back to the database associated with the DBMS 106A-106N, the extensible computation engine 100 or the extensible memory cache 102. In one embodiment, an interface may be provided for the user 120 to indicate a reason for making the modifications. Reasons may include, but are not limited to, management adjustment, customer demand, price adjustment, and error correction.

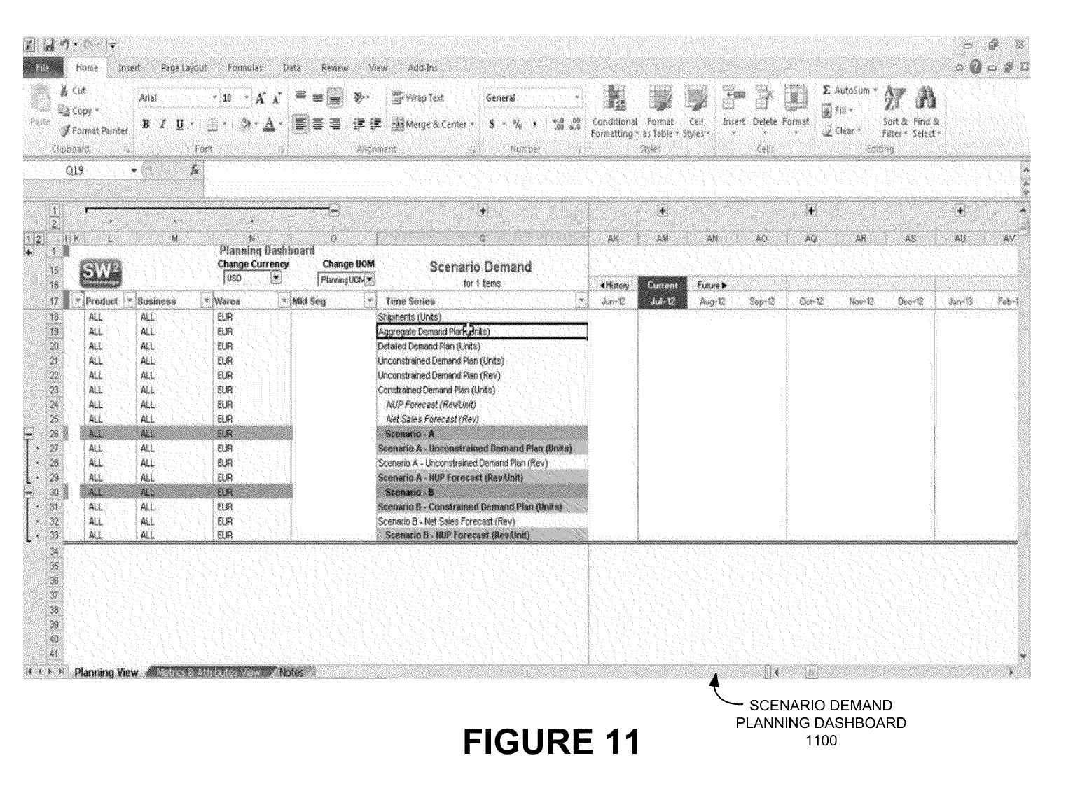

Reference is now made to FIG. 11, which illustrates a scenario demand planning dashboard 1100 associated with a machine-implemented advanced planning and forecasting system. The scenario demand planning dashboard 1100 may provide a user-readable representation of the advanced planning and forecasting raw data 108 and/or the advanced planning simulation results. In one embodiment, the scenario demand planning dashboard 1100 may display data relating to the scenario portion of the process flow shown in FIG. 4. The scenario demand planning dashboard 1100 may be communicatively coupled to a database associated with the DBMS 106A-106N, the extensible computation engine 100 or the extensible memory cache 102. The scenario demand planning dashboard 1100 may include product data, business data, area data, market segment data, and time series data. The time series data may include parameters such as aggregate demand plan, detailed demand plan, unconstrained demand plan for at least one specific scenario, and constrained demand plan for at least one specific scenario. Data in the scenario demand planning dashboard 1100 may be modified by a user 120, for example an account manager, to send a result back to the database associated with the DBMS 106A-106N, the extensible computation engine 100 or the extensible memory cache 102.

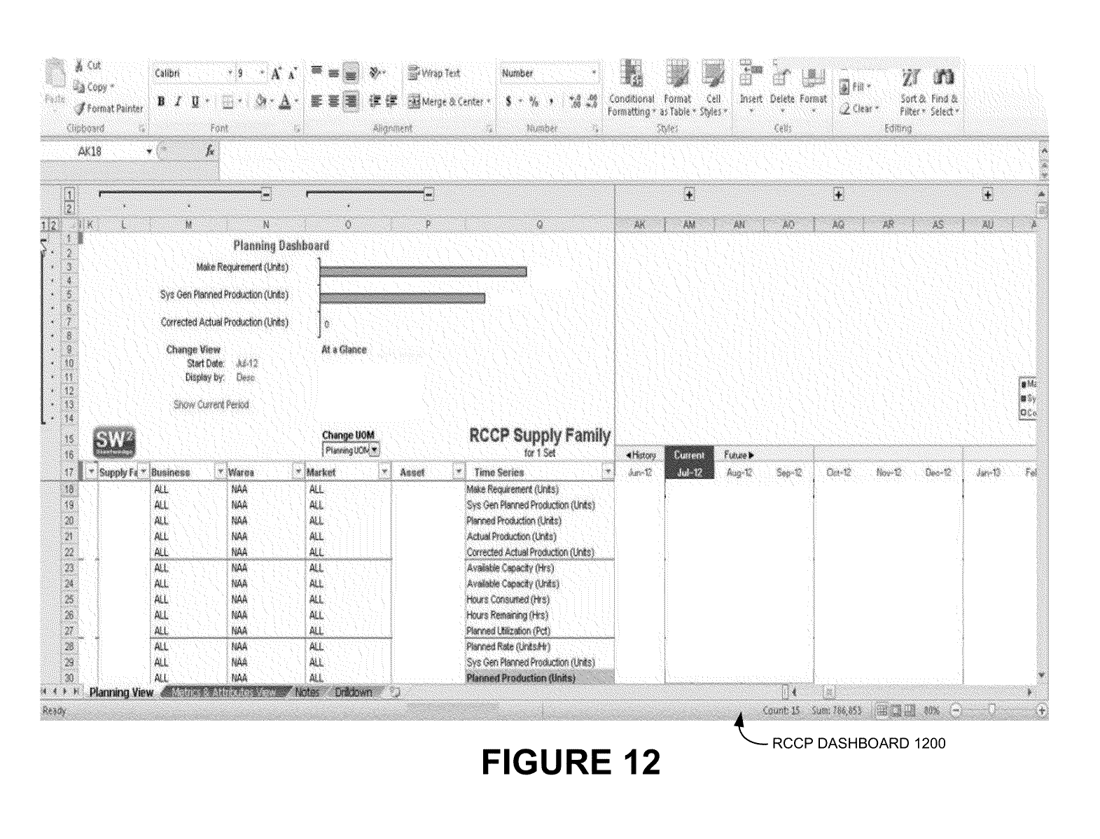

Reference is now made to FIG. 12, which illustrates a RCCP dashboard 1200 associated with a machine-implemented advanced planning and forecasting system. The RCCP dashboard 1200 may provide information related to capacity limits. The RCCP dashboard 1200 may provide a user-readable representation of the advanced planning and forecasting raw data 108 and/or the advanced planning simulation results. In one embodiment, the RCCP dashboard 1200 may display data relating to the demand demand/supply balancing portion of the process flow shown in FIG. 4. The RCCP dashboard 1200 may be communicatively coupled to a database associated with the DBMS 106A-106N, the extensible computation engine 100 or the extensible memory cache 102. The RCCP dashboard 1200 may include family, data, customer data, source data and time series data. The RCCP dashboard 1200 may also include a planning dashboard that may display a graphical representation of an unconstrained build plan, a capacity limit, and a production plan. The RCCP dashboard 1200 may also include a graphical representation of the time series data. Data in the demand planning dashboard 1200 may be modified by a user 120, for example an account manager, to send a result back to the database associated with the DBMS 106A-106N, the extensible computation engine 100 or the extensible memory cache 102. In one example, the RCCP dashboard 1200 may be modified to take corrective action in view of a capacity constraint by increasing the production plan prior to the capacity constraint.

In one embodiment, the demand and supply balancing dashboard 800, the manufacturing capability dashboard 900, the demand planning dashboard 1000, the scenario demand planning dashboard 1100, and/or the RCCP dashboard 1200 may include a toolbar providing the user 120 with quick access to advanced planning and forecasting functions. The tool bar may provide a link for the user to submit a modification, for example an override. An override may allow the user 120 to modify a forecast value and/or time series data. The user 120 may be provided with an interface to submit a reason code and/or notes to provide more information on changes made to the data. Additionally, the tool bar may provide a drilldown function that the user 120 may select to obtain more detail and/or audit trails in relation to data entries. In some examples, the user 120 may use the drilldown functionality to perform inquiries into abnormalities in data entries.

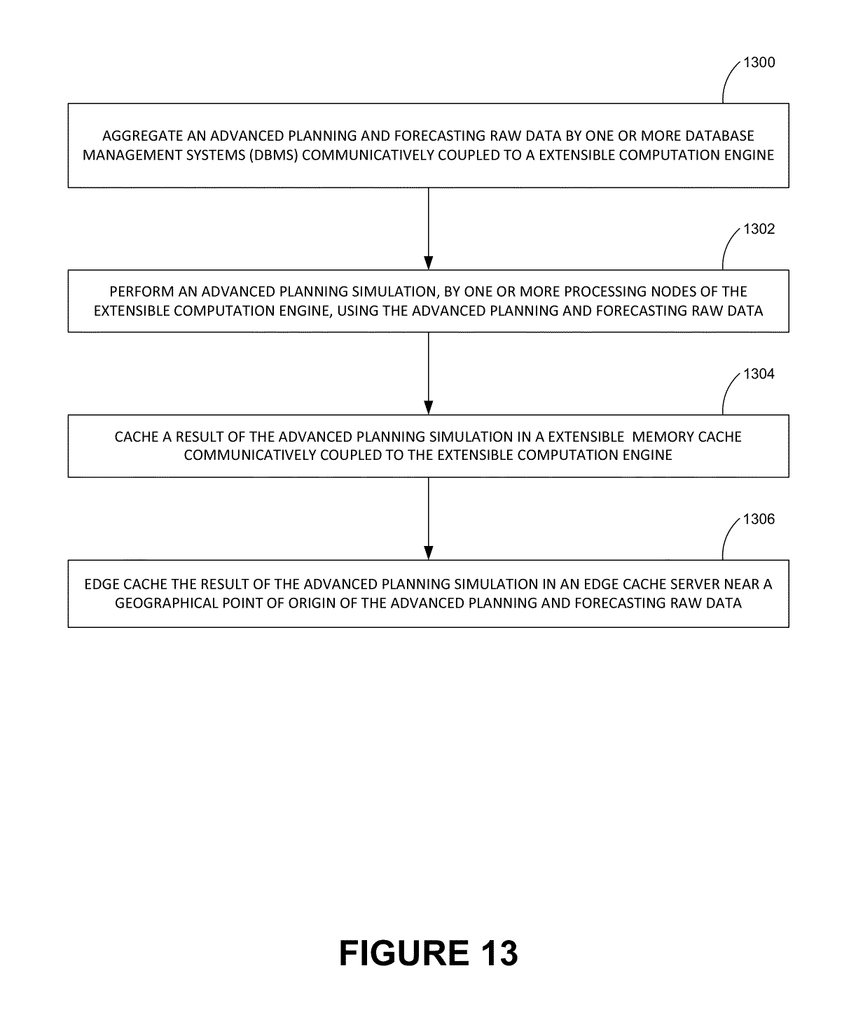

Reference is now made to FIG. 13, which is a flowchart illustrating the machine-implemented method of advanced planning and forecasting of a business enterprise, according to one or more embodiments. Operation 1300 involves aggregating an advanced planning and forecasting raw data 108 by one or more database management systems (DBMS) 106A-106N communicatively coupled to an extensible computation engine 100. Operation 1302 involves performing an advanced planning simulation, by one or more processing nodes of the extensible computation engine 100, using the advanced planning and forecasting raw data 108. Operation 1304 involves caching a result of the advanced planning simulation in an extensible memory cache 102 communicatively coupled to the extensible computation engine 100. Operation 1306 involves edge caching the result of the advanced planning simulation in an edge cache server 116 near a geographical point of origin of the advanced planning and forecasting raw data 108.

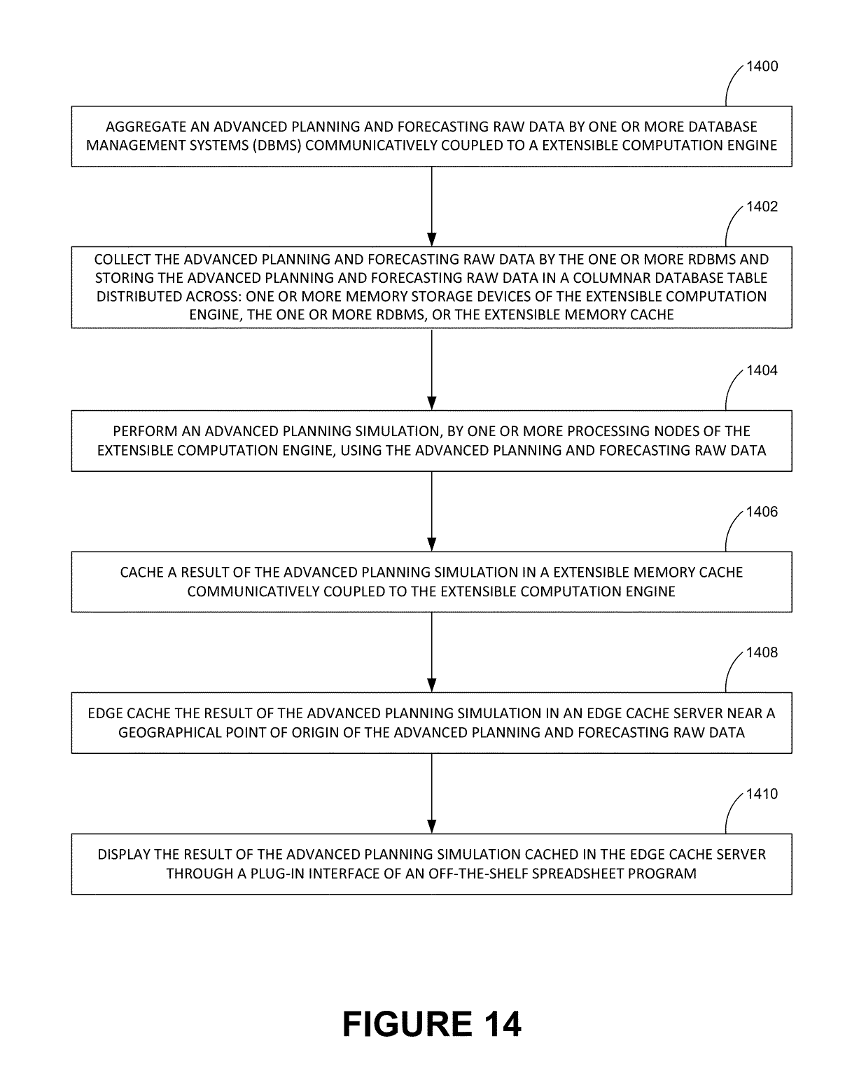

Reference is now made to FIG. 14, which is a flowchart illustrating the machine-implemented method of advanced planning and forecasting of a business enterprise, according to one or more embodiments. FIG. 14 depicts the process flows described in FIG. 14 with additional operations for collecting and storing advanced planning and forecasting raw data 108, and displaying the result of the advanced planning simulation. Operation 1400 involves aggregating an advanced planning and forecasting raw data 108 by one or more database management systems (DBMS) 106A-106N communicatively coupled to an extensible computation engine 100. Operation 1402 involves collecting the advanced planning and forecasting raw data 108 by the one or more DBMS 106A-106N and storing the advanced planning and forecasting raw data 108 in a columnar database table distributed across: one or more memory storage devices of the extensible computation engine 100, the one or more DBMS 106A-106N, or the extensible memory cache 102. Operation 1404 involves performing an advanced planning simulation, by one or more processing nodes of the extensible computation engine 100, using the advanced planning and forecasting raw data 108. Operation 1406 involves caching a result of the advanced planning simulation in an extensible memory cache 102 communicatively coupled to the extensible computation engine 100. Operation 1408 involves edge caching the result of the advanced planning simulation in an edge cache server 116 near a geographical point of origin of advanced planning and forecasting raw data 108. Operation 1410 involves displaying the result of the advanced planning simulation cached in the edge cache server 116 through a plug-in interface 200A of an off-the-shelf spreadsheet program.

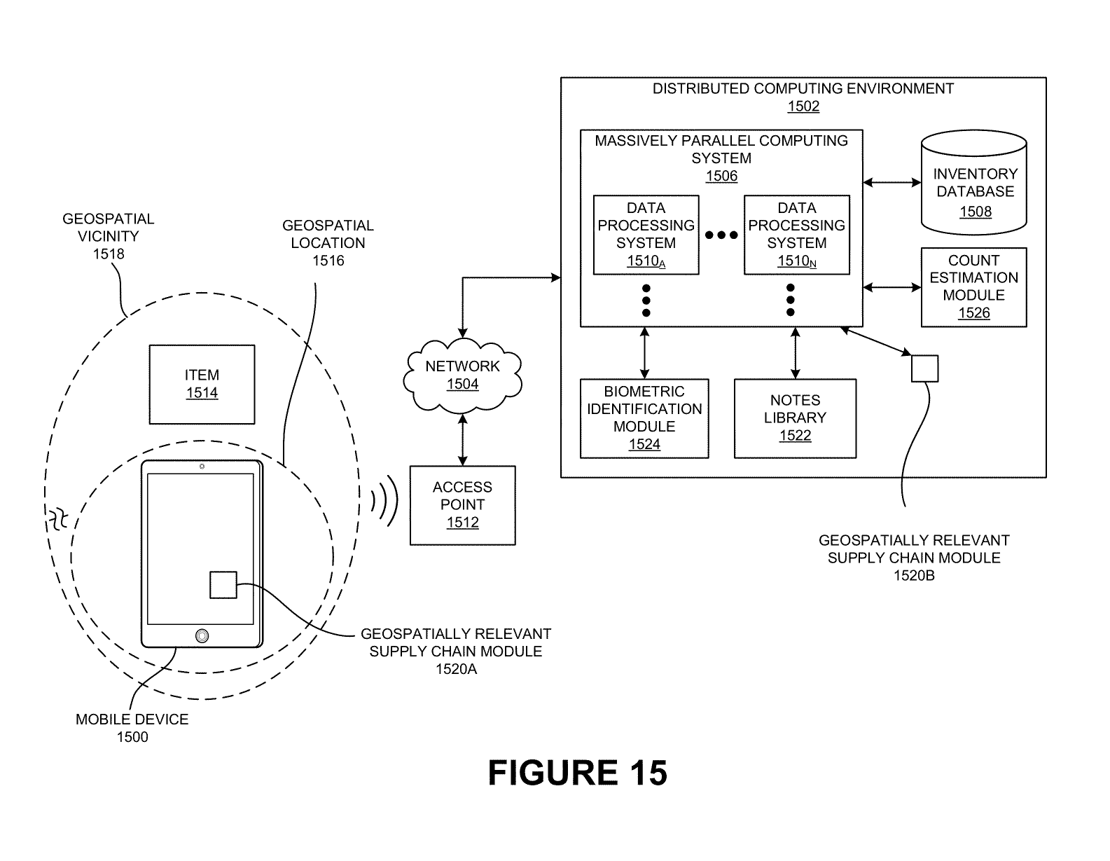

FIG. 15 is a network view of a mobile device 1500 communicatively coupled with a distributed computing environment 1502 through a network 1504. In FIG. 15, the mobile device 1500 is illustrated as including a geospatially relevant supply chain module 1520. The geospatially relevant supply chain module 1520 coordinates interactions between the mobile device 1500 and the distributed computing environment 1502 according to one embodiment. A counter-part geospatial data response module may reside on the massively parallel computing system 1506 in one embodiment. An item 1514 is illustrated as being in in a geospatial vicinity 1518 of a geospatial location 1516 (a present geospatial location) of the mobile device 1500, and thereby an inferably a user that currently has the mobile device with them (e.g., such as on a factory floor).

In the embodiment of FIG. 15, the mobile device 1500 is communicatively coupled with the distributed computing environment 1502 through an access point 1512 which may be inside a local area network in which the mobile device 1500 operates. In other embodiments, the mobile device 1500 may operate over another type of cellular network, such as wideband cellular network (e.g., a 4G network). The distributed computing environment 1502 may be the extensible computing engine 100 of FIG. 1 coupled with the databases 106A-N as previously described in FIG. 1, in one embodiment.

The distributed computing environment 1502 is illustrated as including a massively parallel computing system 1506 having data processing systems 1510 (e.g., same as processing nodes (104-N) in one embodiment as previously described in FIG. 1). The massively parallel computing system 1506 is illustrated as communicatively coupled with a biometric identification module 1524 and a notes library 1522. The biometric identification module 1524 may identify the present geospatial location of the user of the mobile device 1500 in one embodiment. The notes library 1522 may be used to request, capture, and store audio notes 1714 captured through the mobile device 1500, according to one embodiment. The distributed computing environment 1502 is also illustrated as being communicatively coupled with an inventory database 1508 and a count estimation module 1526. The inventory database 1508 may be the DBMS 106 as described in FIG. 1. The count estimation module 1526 may be used to determine an approximate supply chain risk exposure based on estimated inventory counts are counted at a present geospatial location 1516 of the mobile device 1500. In addition, the count estimation module 1526 may be used to determine a type, a count, a quantity, and an approximate cost of inventory that the mobile device 1500 takes pictures of using a built in camera of the mobile device 1500.

In one embodiment of FIG. 15, a method includes accessing an inventory database 1508 remotely stored in a distributed computing environment 1502 through a network 1504 in which the mobile device 1500 operates based on a present geospatial location 1516 of the mobile device 1500, automatically submitting a query to the inventory database 1508 from the mobile device 1500 requesting a stock keeping unit information (1712A-N), an inventory count information (inventory county view 1702), an inventory type information, and/or a min/max level of an item 1514 in a present geospatial vicinity 1518 of the mobile device 1500 using a processor and/or a memory of the mobile device 1500, analyzing a response to the query through a massively parallel computing system 1506 accessed by the mobile device 1500 through the network 1504, and presenting to a user of the mobile device 1500 an expected value of the stock keeping unit information (1712A-N), the inventory count information (inventory county view 1702), the inventory type information, the inventory type information, and the min/max level of an item 1514 based on the analysis.

A geospatial location 1516 of the mobile device 1500 is then determined and communicated to the geospatial location 1516 to the massively parallel computing system 1506 when submitting the query to the inventory database 1508 from the mobile device 1500 requesting a stock keeping unit information (1712A-N), an inventory count information (inventory county view 1702), the inventory type information, and a min/max level of an item 1514 in a present geospatial vicinity 1518 of the mobile device 1500.

The inventory database 1508 may be populated through the mobile device 1500 when the user updates the stock keeping unit information (1712A-N), the inventory count information (inventory county view 1702), the inventory type information and/or the min/max level of an item 1514 in a present geospatial vicinity 1518 of the mobile device 1500. An audio recording capability of the mobile device 1500 may be utilized to append an audio note 1704 to the updates the stock keeping unit information (1712A-N), the inventory count information (inventory county view 1702), the inventory type information and/or the min/max level of an item 1514 in a present geospatial vicinity 1518 of the mobile device 1500.

The user may access and/or play the audio note 1704 from a notes library 1522 remotely stored in a notes library 1522 automatically associated with the stock keeping unit information (1712A-N), the inventory count information (inventory county view 1702), the inventory type information and/or the min/max level of an item 1514 in a present geospatial vicinity 1518 of the mobile device 1500. The user of the inventory database 1508, the massively parallel computing system 1506, and/or the notes library 1522 may be authenticated through a biometric identification module 1524 that compares a visual image, an auditory sample, a haptic gesture, a fingerprint, a password, and/or an iris scan of the user captured with the mobile device 1500 with an authentication database prior to granting the user access to the inventory database 1508, the massively parallel computing system 1506, and/or the notes library 1522.

An access level of the user using the authentication database may be determined. The user may be granted access to a portion of the database based on the access level. A visual image of a location of any number of the item 1514 through them mobile device 1500 may be captured. The visual image of the location of the plurality of the item 1514 may be stored in the visual database. A count of the item 1514 may be automatically estimated when an inventory estimation algorithm is applied to the visual image based on the inventory type information (using the count estimation module 1526). The method may be a machine-implemented method of advanced planning and/or forecasting of a computer supply chain, an electronics supply chain, a chemical industry supply chain, an automotive supply chain, and/or a retail distribution supply chain through massively parallel processing of data using the distributed computing environment 1502.

An advanced planning and/or forecasting raw data may be aggregated by one or more database management systems (DBMS) communicatively coupled to an extensible computation engine. An advanced planning simulation may be performed, by one or more processing nodes of the extensible computation engine, using the advanced planning and/or forecasting raw data. A result of the advanced planning simulation may be cached in an extensible memory cache communicatively coupled to the extensible computation engine. The result of the advanced planning simulation may be edge cached in an edge cache server near a geographical point of origin of the advanced planning and/or forecasting raw data.

The advanced planning and/or forecasting raw data may be a historical or forward-looking data input from an enterprise resource planning (ERP) system. The result of the advanced planning simulation cached in the edge cache server may be displayed through a plug-in interface of an off-the-shelf spreadsheet program operating through the mobile device 1500. The result of the advanced planning simulation cached in the edge cache server through a web based spreadsheet program operating through the mobile device 1500 may be displayed.

The edge caching of the result of the advanced planning simulation may be accelerated by a toll route of data transmission. The advanced planning and/or forecasting raw data may be collected by the one or more storage devices of the extensible computation engine and/or the one or more DBMS and/or storing the advanced planning and/or forecasting raw data in a columnar database table distributed across one or more memory storage devices of the extensible computation engine, the one or more DBMS, or the extensible memory cache. A historical or forward-looking profitability of the business enterprise may be modeled using the advanced planning and/or forecasting raw data. A demand and/or supply plan of the business enterprise may be modeled using the advanced planning and/or forecasting raw data. A capacity constraint of the business enterprise may be modeled using the advanced planning and/or forecasting raw data. A new product introduction by the business enterprise may be modeled using the advanced planning and/or forecasting raw data. A weekly, a multi-week, a monthly, a multi-month, a yearly, and/or a multi-year financial forecast of the business enterprise may be extrapolated using the advanced planning and/or forecasting raw data. The advanced planning simulation may further include balancing a demand criteria, a supply criteria, and/or a finance criteria of the business enterprise using the advanced planning and/or forecasting raw data. The advanced planning simulation may further include modeling a what-if scenario at a demand forecasting stage and/or a supply forecasting stage of the business enterprise using the advanced planning and/or forecasting raw data, and modeling a financial scenario at a demand forecasting stage and/or a supply forecasting stage of the business enterprise using the advanced planning and/or forecasting raw data.

In another aspect, a system of advanced planning and/or forecasting through massively parallel processing of data using a distributed computing environment 1502, includes one or more database management systems (DBMS) to aggregate an advanced planning and/or forecasting raw data, an extensible computation engine communicatively coupled to the one or more DBMS, one or more processing nodes of the extensible computation engine to perform an advanced planning simulation using the advanced planning and/or forecasting raw data, an extensible memory cache, communicatively coupled to the extensible computation engine, to cache a result of the advanced planning simulation, and an edge cache server near a geographical point of origin of the advanced planning and/or forecasting raw data to edge cache the result of the advanced planning simulation.

The advanced planning and/or forecasting raw data is a historical or forward-looking data input from an enterprise resource planning (ERP) program, a customer relationship management (CRM) program, a supplier relationship management (SRM) program, a material resource planning (MRP) program, a stock-keeping unit (SKU) database, and/or a user client device. The system also includes a mobile device 1500 to automatically submit a query to an inventory database 1508 of the DBMS that is communicatively coupled with the mobile device 1500 through the extensible computing engine that requests a stock keeping unit information (1712A-N), an inventory count information (inventory county view 1702), an inventory type information, and/or a min/max level of an item 1514 in a present geospatial vicinity 1518 of the mobile device 1500 using a processor and/or a memory of the mobile device 1500. The mobile device 1500 analyzes a response to the query through a massively parallel computing system 1506 accessed by the mobile device 1500 through the network 1504.

The mobile device 1500 presents to a user of the mobile device 1500 an expected value of the stock keeping unit information (1712A-N), the inventory count information (inventory county view 1702), the inventory type information, the inventory type information, and/or the min/max level of an item 1514 based on the analysis. The result of the advanced planning simulation cached in the edge cache server is displayed through a plug-in interface of an off-the-shelf spreadsheet program operating on the mobile device 1500.

In yet another aspect, a non-transitory medium, readable through one or more processing nodes of an extensible computation engine and/or including instructions embodied therein that are executable through the one or more processing nodes, includes

(1) instructions to aggregate an advanced planning and/or forecasting raw data by one or more database management systems (DBMS) communicatively coupled to the extensible computation engine,

(2) instructions to perform an advanced planning simulation, by the one or more processing nodes of the extensible computation engine, using the advanced planning and/or forecasting raw data,

(3) instructions to cache a result of the advanced planning simulation in an extensible memory cache communicatively coupled to the extensible computation engine,

(4) instructions to edge cache the result of the advanced planning simulation in an edge cache server near a geographical point of origin of the advanced planning and/or forecasting raw data. The advanced planning and/or forecasting raw data is a historical or forward-looking data input from an enterprise resource planning (ERP) program, a customer relationship management (CRM) program, a supplier relationship management (SRM) program, a material resource planning (MRP) program, a stock-keeping unit (SKU) database, and/or a user client device, and

(5) instructions to automatically respond to a query from a mobile device 1500 communicatively coupled to an inventory database 1508 of the DBMS that is communicatively coupled with the mobile device 1500 through the extensible computing engine that requests a stock keeping unit information (1712A-N), an inventory count information (inventory county view 1702), an inventory type information, and/or a min/max level of an item 1514 in a present geospatial vicinity 1518 of the mobile device 1500.

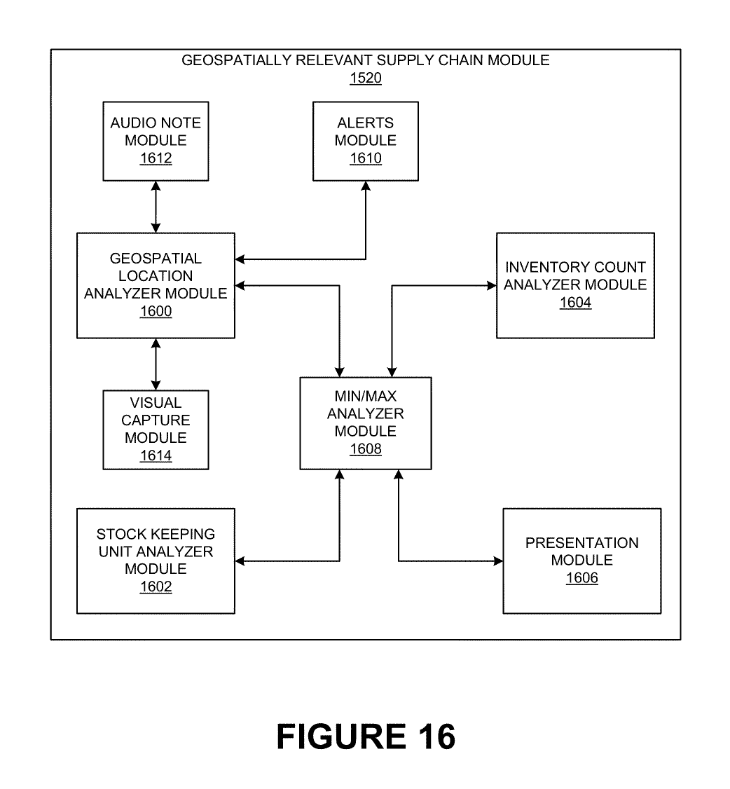

FIG. 16 is an exploded view of the geospatially relevant supply chain module 1520. Note, a portion of the geospatially relevant supply chain module 1520A may operate in the mobile device 1500 (client side) while another portion may operate in concert on the distributed computing environment 1502 communicatively coupled with the mobile device 1500. In other embodiments, the entire function of the geospatially relevant supply chain module may be in the distributed computing environment 1502 and operated using the cloud computing, massively parallel computing system 1506 cluster as described in FIG. 15.

In FIG. 16, the geospatially relevant supply chain module 1520 is illustrated as including a geospatial location analyzer module 1600, a stock keeping unit analyzer module 1602, an inventory count analyzer module 1604, a presentation module 1606, a min/max analyzer module 1608, an alerts module 1610, an audio note module 1612, and a visual capture module 1614. The stock keeping unit analyzer module 1602 may analyze a count of an stock keeping unit (e.g., can be multiple quantities of inventory in a stock keeping unit) based on a present geospatial location 1516 of the mobile device 1500. The inventory count analyzer module 1604 may analyze a count of inventory quantity and type based on a present geospatial location 1516 of the mobile device 1500. The presentation module 1606 may determine how to represent data on the mobile device 1500 (e.g., based on perspective in a three dimensional view of the inventory and/or the factory floor) based on a present geospatial location 1516, angle, and directional compass in which the individual holding the mobile device 1500 can be inferred to be standing, in one embodiment. The min/max analyzer module 1608 may determine and present an optimal minimum/maximum level of an inventory of an item 1514 that the user of the mobile device 1500 is currently in front of based on the present geospatial location 1516, angle, and directional compass in which the individual holding the mobile device 1500, in one embodiment. It will be appreciated with those with skill in the art that, various other combinations may be possible and each described here can be used in concert and/or in a combined form, in one embodiment.

The alerts module 1610 can inform a user about an alert based on a data based on based on the present geospatial location 1516, angle, and directional compass in which the individual holding the mobile device 1500, in one embodiment. The audio note module 1612 can enable the user of the mobile device 1500 to leave an audio note 1704 for the item 1514 and/or nearby environmental factors (e.g., location, temperature, employee count, shelf condition, etc.) based on the present geospatial location 1516, angle, and directional compass in which the individual holding the mobile device 1500, in one embodiment. The visual capture module 1614 may enable the user of the mobile device 1500 to capture a visual image and/or video of notes and/or an environmental condition/factor based on the present geospatial location 1516, angle, and directional compass in which the individual holding the mobile device 1500, in one embodiment.

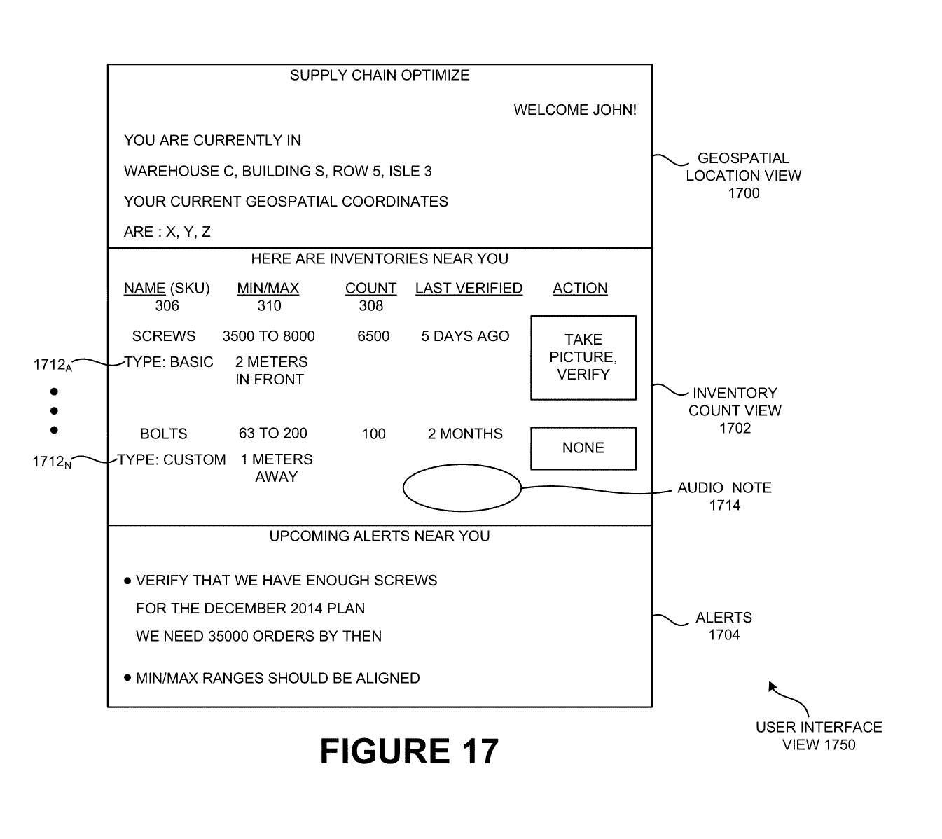

FIG. 17 is a user interface view 1750 of the mobile device 1500 according to one embodiment. In FIG. 17, a user of the mobile device 1500 is presented with information based on the present geospatial location 1516, angle, and directional compass in which the individual holding the mobile device 1500, according to one embodiment, in one embodiment. The user interface of FIG. 17 indicates where the individual operating the mobile device 1500 is currently and what inventory is near the user. It also indicates alerts 1704 that need to be addressed by the user of the mobile device 1500 related to actions in a factory floor that need immediate attention, in one embodiment.

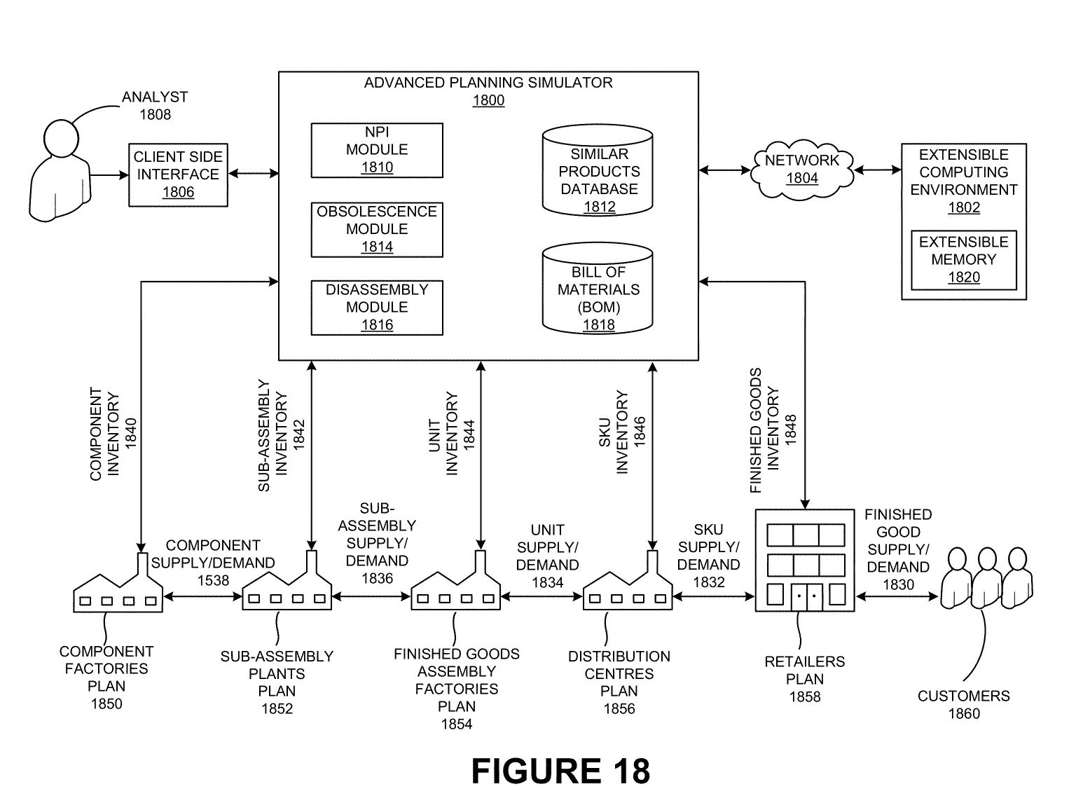

FIG. 18 is an electronics and computer industry supply chain view leveraging a distributed computing environment, according to one embodiment. Reference is now made to FIG. 18, which illustrates an electronics supply chain modeled and driven by an advanced planning simulator 1800. Volatility and/or complexity in the electronics industry may necessitate intensive computation for accurate electronics supply chain simulations and forecasting. The advanced planning simulator 1800 may therefore be run on an extensible computing environment 1802. The extensible computing environment 1802 may comprise a number of processors that operate in parallel (e.g. in a single server, across multiple servers directly coupled or connected across a network, in a cloud computing environment, etc.). The extensible computing environment may further comprise an extensible memory 1820, which may be centralized on one server or distributed across multiple servers. In one or more embodiments, the extensible computing environment may be the extensible computation engine 100 of FIG. 1 and the extensible memory 1824 may be the extensible memory cache 102 of FIG. 1. The Extensible computing environment 1802 may be accessible through a network 1804.

A client side interface coupled directly or indirectly to the advance planning simulator 1800 may enable an analyst 1808 (e.g. the user 120 of FIG. 1) to determine and initiate a simulation, and visualize the results (e.g., using the various distributed computing based methods described in FIGS. 1-19). The client side interface 1806 may be the network 118 and the edge cache server 116 of FIG. 1. The client side interface 1806 may be the network 118 and the edge cache server 116 of FIG. 1.

In one or more embodiments, the advance planning simulator 1800 may comprise a new product introduction (NPI) module 1810. The NPI module 1810 may predict the demand for a new product and/or simulate a supply chain for the new product based on one or more histories of similar products (e.g. competitor products, old generation products in the same line, etc.) as accessed through a similar products database 1812. The demand prediction and/or supply chain simulation may be computationally intensive when based on multiple histories of similar products. The NPI module may therefore be run in the extensible computation environment 100. Furthermore, the similar products database may be stored in the extensible memory 1820.

In one or more embodiments, the advanced planning simulator 1800 may also comprise an obsolescence module 1814 (i.e. a module simulating a supply chain of an end of life product) and a disassembly module 1816. The disassembly may identify components or sub-assemblies in common between an end of life product supply chain simulated by the obsolescence module 1814 and a new product supply chain simulated by the NPI module 1810. The advanced planning simulator 1800 may also comprise a bill of materials (BOM) 1818. The BOM 1818 may be a list of raw materials, sub-assemblies, intermediate assemblies, sub-components, parts, the quantities of each needed to manufacture the new product, and/or lead times of each. The BOM 1818 may be an extensive list and may therefore be stored in the extensible memory 1820. The disassembly module 1816 may access at least one bill of materials (BOM) 1818 to identify one or more components and/or sub-assemblies in of the end of life product that may be reused in the new product. Furthermore, the obsolescence module 1814 and/or disassembly module 1816 may be run in the extensible computation environment 100. In one or more embodiments, the NPI module may be configurable to simulate a new product supply chain in which one or more sub-assemblies and/or components in the end of life product are reused in the new product.

In one or more embodiments, the NPI module 1810 may simulate a new product supply and/or demand relationship between electronics supply chain nodes (e.g. components factory, sub-assembly plant, finished goods assembly factory, retailer, etc.) in the electronics supply chain. For example, the NPI module may simulate and/or model a finished good supply/demand 1830, a stock keeping unit supply/demand 1832, a unit supply/demand, sub-assembly supply/demand 1836, and/or a component supply/demand 1836. The NPI module 1810 may simulate the supply and/or demand relationship based on a history of a component inventory 1840, a sub-assembly inventory 1842, a unit inventory 1844, a SKU inventory 1846, and/or a finished goods inventory 1848. In one or more embodiments, the inventories and supply/demand relationships described herein may be the advanced planning and forecasting raw data 108 of FIG. 1.

In one or more embodiments, the NPI module may generate a plan (e.g. determine a max/min inventory, sourcing, 3PL, pricing, etc.) at one or more electronics supply chain nodes on a demand simulation and/or additional considerations (e.g. storage capacity of different electronics supply chain nodes, storage cost, lead times, labor cost, utility costs, 3PL, analysis of final goods demand based on competitive products, etc.). In one or more embodiments the NPI module 1810 may develop a component factories plan 1850, a sub-assembly plants plan 1852, a finished goods assembly factories plan 1854, a distribution centers plan 1856, and/or a retailers plan 1858. The NPI module 1810 may take into account the inventory readouts and additional considerations for a number of components and/or or sub-assemblies at one or more electronics supply chain nodes, which may be computationally intensive. The NPI module may therefore be run in the extensible computing environment 1802. The NPI module may be configurable to compare plans to identify one or more plans that meet a finished goods demand determined by customers 1860, where the finished goods are at a supply and/or price that maximizes profit.

In one or more embodiments, the obsolescence module 1814 may perform functions similar to those described for the NPI module 1810. The modules of the advanced planning simulator 1800 disclosed herein are exemplary, and the functions of the modules could be grouped into other modules while remaining within the scope of the embodiments disclosed herein. Other modules familiar to one of ordinary skill in the art are within the scope of the embodiments disclosed herein.

It should be noted that in a computer and electronics industry supply chain, a number of factors may contribute to uniqueness of a problem set that result in the benefits of the distributed computing design based on cloud computing based processing of supply chain data in the computer and electronics arts, as described in the various embodiments herein. For example, computer models may change yearly, with minor upgrades to features and internal and/or external components requiring frequent simulation not otherwise possible without the various embodiments described herein.

For example, processing power of the distributed computing environment 1502 of the extensible computing engine 100 may enable an analyst to make needed supply and demand changes to upstream and downstream supply computer distributor, manufacture, and subassembly factory/supplier chains to ensure predictable, cost effective and just in time models by leveraging the massively parallel architecture of a distributed computing environment shared across many businesses (as described in the various embodiments herein) rather than just a computing power available in the enterprise to analyze and create what-if scenario based supply and demand plans for scenarios such as (1) high degree of modularity of a design may be desired to minimize cost and preserve flexibility until a last stage before finished good creation (2) widely fluctuating market demand based on external product releases and yield gains (3) obsolesce risk mitigation simulation and disruptive technologies affecting market demand and/or (4) periodic model revision of the computer and electronics industry supply chain.

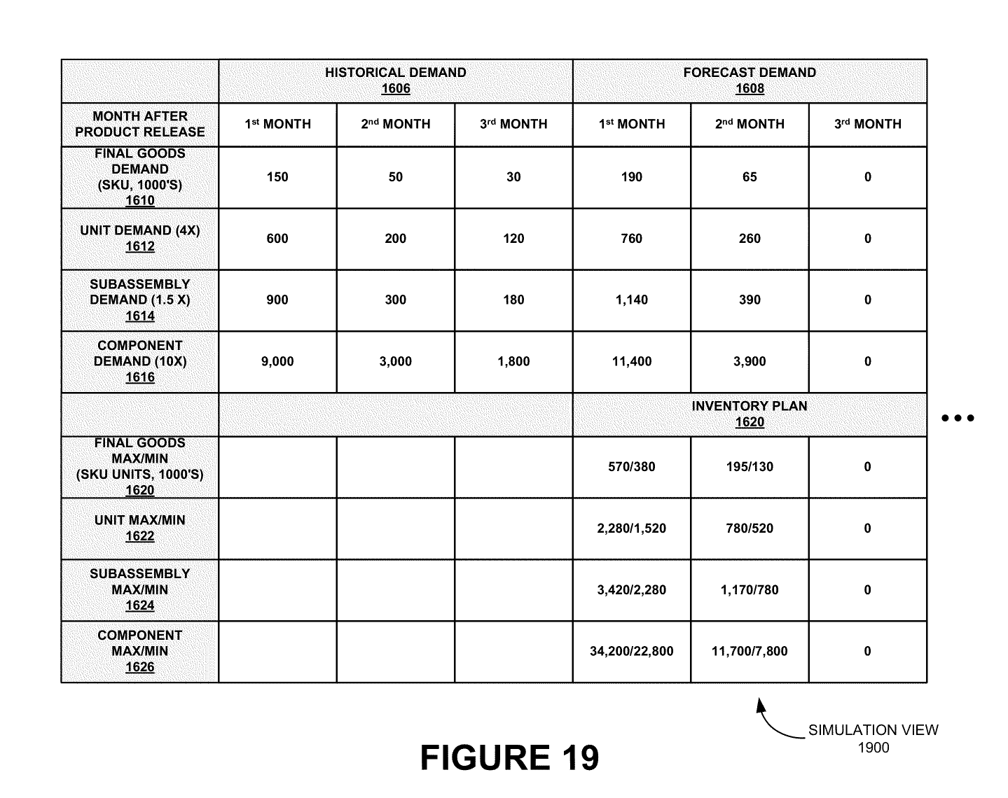

FIG. 19 is a simulation view of the electronics and computer industry supply chain view leveraging the distributed computing environment, according to one embodiment. Reference is now made to FIG. 19, which is a simulation view 1900 of a forecast demand 1908 and an inventory plan 1920 for different nodes in an electronics supply chain generated by the advanced planning simulator 1800 of FIG. 18. In one or more embodiments, the simulation view 1900 may be presented to the user 120 through the network 118 of FIG. 1. In one or more embodiments, a historical demand 1906 may be based on a history of the forecasted product and/or a history of a similar product. The forecast demand 1908 may be based at least in part on the historical demand 1906. In one or more embodiments, the forecast demand may be further based on an analysis of competitor products currently in the market, a final goods pricing impact on elastic demand, and the demand from downstream electronics supply chain nodes. For example, the forecast demand 1908 may be simulated to follow the trend of the historical demand 1906 of a similar product until a next generation product is released which will drive demand down. The simulation view 1900 may forecast at least one of a final good demand 210, a unit demand 212, a sub-assembly demand 214, and a component demand 216.

In one or more embodiments, the inventory plan 1920 may comprise a list of min/max inventory recommendations at one or more electronics supply chain nodes. For example, the inventory plan 1920 may comprise a final goods max/min 1920, a unit max/min 1922, a sub-assembly max/min 1924, and/or a component max/min 1926. The volatile nature of an electronics supply chain may require a larger max/min margin in the inventory plan 1920 compared to another supply chain.

A number of embodiments have been described. Nevertheless, it will be understood that various modifications may be made without departing from the spirit and scope of the claimed invention. In addition, the logic flows depicted in the figures do not require the particular order shown, or sequential order, to achieve desirable results. In addition, other steps may be provided, or steps may be eliminated, from the described flows, and other components may be added to, or removed from, the described systems. Accordingly, other embodiments are within the scope of the following claims.

It may be appreciated that the various systems, methods, and apparatus disclosed herein may be embodied in a machine-readable medium and/or a machine accessible medium compatible with a data processing system (e.g., a computer system), and/or may be performed in any order.

The structures and modules in the figures may be shown as distinct and communicating with only a few specific structures and not others. The structures may be merged with each other, may perform overlapping functions, and may communicate with other structures not shown to be connected in the figures. Accordingly, the specification and/or drawings may be regarded in an illustrative rather than a restrictive sense.

The process flows and flow diagrams depicted in the figures do not require the particular order shown, or sequential order, to achieve desirable results. In addition, others may be provided, or steps may be eliminated from the described flows, and other components may be added to or removed from the depictions.

1. A machine-implemented method of advanced planning and forecasting of a computer and electronics industry supply chain through massively parallel processing of data using a distributed computing environment, comprising:
aggregating an advanced planning and forecasting raw data by one or more database management systems (DBMS) communicatively coupled to an extensible computation engine;
performing an advanced planning simulation modeling a multi-level bill of materials of the computer and electronics industry supply chain, a periodic model revision of the computer and electronics industry supply chain, and an obsolesce risk of the computer and electronics industry supply chain, by one or more processing nodes of the extensible computation engine, using the advanced planning and forecasting raw data; wherein the advanced planning simulation generates a result based on the user profile of a user;
caching the result of the advanced planning simulation in an extensible memory cache communicatively coupled to the extensible computation engine; and
edge caching the result of the advanced planning simulation in an edge cache server near a geographical point of origin of the advanced planning and forecasting raw data, wherein the result is based on a profile of a user associated with the geographical location,
wherein the advanced planning and forecasting raw data is a historical or forward-looking data input from at least one of an enterprise resource planning (ERP) program, a customer relationship management (CRM) program, a supplier relationship management (SRM) program, a material resource planning (MRP) program, a stock-keeping unit (SKU) database, and a user client device.

2. The method of claim 1, further comprising: displaying the result of the advanced planning simulation cached in the edge cache server through a plug-in interface of an off-the-shelf spreadsheet program.

3. The method of claim 1, further comprising: displaying the result of the advanced planning simulation cached in the edge cache server through a web based spreadsheet program.

4. The method of claim 1, wherein the edge caching of the result of the advanced planning simulation is accelerated by a toll route of data transmission.

5. The method of claim 1, further comprising:
collecting the advanced planning and forecasting raw data by the one or more storage devices of the extensible computation engine and the one or more DBMS and storing the advanced planning and forecasting raw data in a columnar database table distributed across: one or more memory storage devices of the extensible computation engine, the one or more DBMS, or the extensible memory cache.

6. The method of claim 1, wherein the advanced planning simulation comprises: modeling a historical or forward-looking profitability of the business enterprise using the advanced planning and forecasting raw data;
modeling a demand and supply plan of the business enterprise using the advanced planning and forecasting raw data;
modeling a capacity constraint of the business enterprise using the advanced planning and forecasting raw data;
modeling a new product introduction by the business enterprise using the advanced planning and forecasting raw data; and
extrapolating at least one of a weekly, a multi-week, a monthly, a multi-month, a yearly, and a multi-year financial forecast of the business enterprise using the advanced planning and forecasting raw data.

7. The method of claim 1, wherein the advanced planning simulation further comprises balancing a demand criteria, a supply criteria, and a finance criteria of the business enterprise using the advanced planning and forecasting raw data.

8. The method of claim 1, wherein the advanced planning simulation further comprises:
modeling a what-if scenario at a demand forecasting stage and a supply forecasting stage of the business enterprise using the advanced planning and forecasting raw data; and
modeling a financial scenario at a demand forecasting stage and a supply forecasting stage of the business enterprise using the advanced planning and forecasting raw data.

9. A system of advanced planning and forecasting through massively parallel processing of data using a distributed computing environment in a computer and electronics industry supply chain, comprising:
one or more database management systems (DBMS) to aggregate an advanced planning and forecasting raw data;
an extensible computation engine communicatively coupled to the one or more DBMS;
one or more processing nodes of the extensible computation engine to perform an advanced planning simulation using the advanced planning and forecasting raw data; wherein the advanced planning simulation generates a result based on the user profile of a user; an extensible memory cache, communicatively coupled to the extensible computation engine, to cache the result of the advanced planning simulation; and
an edge cache server near a geographical point of origin of the advanced planning and forecasting raw data to edge cache the result of the advanced planning simulation, wherein the result is based on a profile of a user associated with the geographical location,
wherein the advanced planning and forecasting raw data is a historical or forward-looking data input from at least one of an enterprise resource planning (ERP) program, a customer relationship management (CRM) program, a supplier relationship management (SRM) program, a material resource planning (MRP) program, a stock-keeping unit (SKU) database, and a user client device.

10. The system of claim 9, wherein the result of the advanced planning simulation cached in the edge cache server is displayed through a plug-in interface of an off-the-shelf spreadsheet program.

11. The system of claim 9, wherein the result of the advanced planning simulation cached in the edge cache server is displayed through a web based spreadsheet program.

12. The system of claim 9, wherein the edge caching of the result of the advanced planning simulation is accelerated by a toll route of data transmission.

13. The system of claim 9, wherein the one or more storage devices of the extensible computation engine and the one or more DBMS collects the advanced planning and forecasting raw data and stores the advanced planning and forecasting raw data in a columnar database table distributed across: one or more memory storage devices of the extensible computation engine, the one or more DBMS, or the extensible memory cache.

14. The system of claim 9, wherein the advanced planning simulation comprises:
modeling a historical or forward-looking profitability of the business enterprise using the advanced planning and forecasting raw data;
modeling a demand and supply plan of the business enterprise using the advanced planning and forecasting raw data;
modeling a capacity constraint of the business enterprise using the advanced planning and forecasting raw data;
modeling a new product introduction by the business enterprise using the advanced planning and forecasting raw data; and
extrapolating at least one of a weekly, a multi-week, a monthly, a multi-month, a yearly, and a multi-year financial forecast of the business enterprise using the advanced planning and forecasting raw data.

15. The system of claim 9, wherein the advanced planning simulation further comprises balancing a demand criteria, a supply criteria, and a finance criteria of the business enterprise using the advanced planning and forecasting raw data.

16. The system of claim 9, wherein the advanced planning simulation further comprises:
modeling a what-if scenario at a demand forecasting stage and a supply forecasting stage of the business enterprise using the advanced planning and forecasting raw data; and
modeling a financial scenario at a demand forecasting stage and a supply forecasting stage of the business enterprise using the advanced planning and forecasting raw data.

17. A non-transitory medium, readable through one or more processing nodes of an extensible computation engine and including instructions
embodied therein that are executable through the one or more processing nodes in a computer and electronics industry supply chain, comprising:
instructions to aggregate an advanced planning and forecasting raw data by one or more database management systems (DBMS) communicatively coupled to the extensible computation engine;
instructions to perform an advanced planning simulation, by the one or more processing nodes of the extensible computation engine, using the advanced planning and forecasting raw data; wherein the advanced planning simulation generates a result based on the user profile of a user;
instructions to cache the result of the advanced planning simulation in an extensible memory cache communicatively coupled to the extensible computation engine; and
instructions to edge cache the result of the advanced planning simulation in an edge cache server near a geographical point of origin of the advanced planning and forecasting raw data, wherein the result is based on a profile of a user associated with the geographical location,
wherein the advanced planning and forecasting raw data is a historical or forward-looking data input from at least one of an enterprise resource planning (ERP) program, a customer relationship management (CRM) program, a supplier relationship management (SRM) program, a material resource planning (MRP) program, a stock-keeping unit (SKU) database, and a user client device.

18. The non-transitory medium of claim 17, further comprising:
instructions to display the result of the advanced planning simulation cached in the edge cache server through a plug-in interface of an off-the-shelf spreadsheet program

19. The non-transitory medium of claim 17, further comprising:
instructions to display the result of the advanced planning simulation cached in the edge cache server through a web based spreadsheet program.

20. The non-transitory medium of claim 17, further comprising:
instructions to collect the advanced planning and forecasting raw data by the one or more memory storage devices of the extensible computation engine and the one or more RDBMS and storing the advanced planning and forecasting raw data in a columnar database table distributed across: one or more memory storage devices of the extensible computation engine, the one or more DBMS, or the extensible memory cache.
